(19) United States
(12) Patent Application Publication
(10) Pub. No.: US 2025/0150564 A1
(43) Pub. Date: May 8, 2025

(54) SIGNAL PROCESSING DEVICE, SIGNAL PROCESSING METHOD, AND PROGRAM

(71) Applicant: SONY SEMICONDUCTOR SOLUTIONS CORPORATION, KANAGAWA (JP)

(72) Inventors: JUNYA MIZUTANI, KANAGAWA (JP); TOSHIHISA MIYAKE, KANAGAWA (JP); KAZUYUKI OKUIKE, KANAGAWA (JP)

(21) Appl. No.: 18/832,281

(22) PCT Filed: Jan. 18, 2023
(86) PCT No.: PCT/JP2023/001343

§ 371 Date: Jul. 23, 2024

(30) Foreign Application Priority Data
Jan. 31, 2022 (JP) 2022-013562

(51) Int. Cl. H04N 9/73; G02B 5/30; H04N 23/88

(52) U.S. Cl. CPC H04N 9/73; G02B 5/3025; H04N 23/88

(57) ABSTRACT

It is attempted to acquire appropriate images in a case where multiple types of images are generated on the basis of an output of a light reception sensor. A signal processing device according to the present technology includes a signal processing section that performs signal processing on at least one image in multiple types of images generated on a basis of an output of a light reception sensor in which pixels having light receiving elements are arrayed two-dimensionally, and a control section that controls a signal processing parameter in the signal processing section such that modes of the multiple types of images become appropriate.

### TECHNICAL FIELD

The present technology relates to a signal processing device including a signal processing section that performs signal processing on at least one image in multiple types of images generated on the basis of an output of a light reception sensor in which pixels having light receiving elements are arrayed two-dimensionally, a method performed by the signal processing device, and a program.

### BACKGROUND ART

There are various types of light reception sensors in which pixels having light receiving elements are arrayed two-dimensionally. For example, examples of such light reception sensors include RGB sensors for obtaining color captured images, distance measurement sensors for obtaining distance images representing distances to subjects, polarization sensors for obtaining polarization images representing polarization information for each pixel, spectral sensors (multi-spectrum sensors) for obtaining multiple narrow-band images to be used as wavelength characteristics analysis images about light from subjects, and the like.

Multiple types of images are generated as narrow-band images on the basis of an output of a spectral sensor in those light reception sensors. In addition, in a case where an iToF (indirect ToF (TOF: Time Of Flight)) sensor is used as a distance measurement sensor, multiple types of images are generated in some cases, as in a case where an IR (infrared) image is generated along with a distance image on the basis of an output of the sensor, and so on. In addition, also in a case where a polarization sensor is used, multiple types of polarization image such as, for example, a polarization component image, a reflection-removed image, or a reflection-enhanced image are generated on the basis of an output of the sensor in some cases, in order to obtain various kinds of polarization information.

Note that examples of related technologies in the past include PTL 1 described below. PTL 1 discloses a technology in which an electronically-zoomed image of a partial area of an image output from a light reception sensor is generated, an evaluation coefficient for exposure is set for each of the electronically-zoomed area and the other area (the whole sensor-output image), and thereby a photometry mode that prioritizes the electronically-zoomed area or a photometry mode for the whole image is selected.

### CITATION LIST

### Patent Literature

[PTL 1]
JP 2007-19726A

### SUMMARY

### Technical Problem

Here, in a case where multiple types of images are generated on the basis of an output of a light reception sensor as described above, differences in characteristics are generated between the respective images due to the differences in type. For example, brightness varies by image even if the same subject is captured, and so on.

For example, if signal processing such as brightness adjustment is performed prioritizing any of multiple types of images in such a case, there is a risk that appropriate image acquisition cannot be performed for reasons such as that a brightness of other images does not become appropriate.

The present technology has been made in view of the problems described above, and an object thereof is to attempt to make it possible to acquire appropriate images in a case where multiple types of images are generated on the basis of an output of a light reception sensor.

### Solution to Problem

A signal processing device according to the present technology includes a signal processing section that performs signal processing on at least one image in multiple types of images generated on the basis of an output of a light reception sensor in which pixels having light receiving elements are arrayed two-dimensionally, and a control section that controls a signal processing parameter in the signal processing section such that modes of the multiple types of images become appropriate.

Thereby, it is attempted to perform signal processing for making it possible to obtain images in appropriate modes in a case where multiple types of images are generated on the basis of an output of the light reception sensor. For example, it is attempted to perform signal processing for making the brightness or white balance of images appropriate or for performing appropriate image generation from multiple images, or the like.

### BRIEF DESCRIPTION OF DRAWINGS

FIG. 1 is a figure for explaining the concept of a signal processing device as an embodiment according to the present technology.

FIG. 2 is a block diagram for explaining a configuration example of a signal processing device as a first example in a first embodiment.

FIG. 3 is a figure schematically depicting a configuration example of a pixel array section of a polarization sensor.

FIG. 4 is a figure illustrating a schematic cross-sectional structure of a pixel of the polarization sensor.

FIG. 5 is a block diagram for explaining an internal configuration example of a polarization image generating section.

FIG. 6 is a figure for explaining an image organization process performed by an image organizing section, and a demosaicing process performed by a demosaicing section.

FIG. 7 is a figure for explaining a process performed by a polarization state estimating section.

FIG. 8 is a figure for explaining an approach to generating various types of polarization image performed by a polarization image generation processing section.

FIG. 9 is a block diagram for explaining a configuration example of a signal processing device as a second example in the first embodiment.

FIG. 10 is a block diagram for explaining a configuration example of a signal processing device as a third example in the first embodiment.

FIG. 11 is a block diagram for explaining a configuration example of a signal processing device as a fourth example in the first embodiment.

FIG. 12 is a figure for explaining an example in which detecting sections are arranged downstream of signal processing sections.

FIG. 13 is a block diagram for explaining a configuration example of a signal processing device as a fifth example in the first embodiment.

FIG. 14 is a block diagram for explaining a configuration example of a signal processing device as a sixth example in the first embodiment.

FIG. 15 is a figure for explaining machine learning corresponding to the configuration depicted in FIG. 14.

FIG. 16 is a block diagram for explaining a configuration example of a signal processing device as another example of the sixth example.

FIG. 17 is a figure for explaining machine learning corresponding to the configuration depicted in FIG. 16.

FIG. 18 is a block diagram for explaining a configuration example of a signal processing device as still another example of the sixth example.

FIG. 19 is a figure for explaining machine learning corresponding to the configuration depicted in FIG. 18.

FIG. 20 is a block diagram for explaining a configuration example of a signal processing device used on the assumption that relearning of an artificial intelligence model is performed.

FIG. 21 is a functional block diagram for explaining a function related to the relearning that the signal processing device depicted in FIG. 20 has.

FIG. 22 is a figure for explaining a color cast of a light source color.

FIG. 23 is a figure for explaining diffused reflection light (diffused reflection component) and specular reflection light (specular reflection component) included in reflection light from a subject.

FIG. 24 is a figure for explaining a scene with a MIX light source.

FIG. 25 is a block diagram for explaining a configuration example of a signal processing device as a seventh example in the first embodiment.

FIG. 26 is a figure for explaining a case where multiple target subjects are sensed in an image frame.

FIG. 27 is a block diagram for explaining a configuration example of a signal processing device having a function to cancel light source colors of each target subject.

FIG. 28 is a figure for explaining an example in which an object sensing section and an RGB detecting section are provided outside a signal processing device.

FIG. 29 is a block diagram for explaining a configuration example of a signal processing device as a first example in a second embodiment.

FIG. 30 is a figure schematically depicting a configuration example of a pixel array section of a spectral sensor.

FIG. 31 is a figure for explaining a linear matrix process for obtaining M narrow-band images.

FIG. 32 is a block diagram for explaining a configuration example of a signal processing device as a second example in the second embodiment.

FIG. 33 is a block diagram for explaining a configuration example of a signal processing device as another example of the second example.

FIG. 34 is a block diagram for explaining a configuration example of a signal processing device as a third example in the second embodiment.

FIG. 35 is a block diagram for explaining a configuration example of a signal processing device that infers detected values of L narrow-band images and an RGB image from a RAW image.

FIG. 36 is a block diagram for explaining a configuration example of a signal processing device that infers detected values of a RAW image and L narrow-band images from an RGB image.

FIG. 37 is a block diagram for explaining a configuration example of a signal processing device as a fourth example in the second embodiment.

FIG. 38 is a figure for explaining an example of calculation of a gain (WB gain) for light source color cancellation.

FIG. 39 is a block diagram for explaining a configuration example of a signal processing device as a first example of a third embodiment.

FIG. 40 is a block diagram depicting an internal circuit configuration example of an iToF sensor included in the signal processing device of the third embodiment.

FIG. 41 is an equivalent circuit diagram of a pixel of the iToF sensor in the third embodiment.

FIG. 42 is a block diagram for explaining a configuration example of a signal processing device having a function to estimate detected values of an IR image.

FIG. 43 is a block diagram for explaining a configuration example of a signal processing device that infers detected values of an IR image from detected values of a RAW image.

FIG. 44 is a block diagram for explaining a configuration example of a signal processing device that infers detected values of a RAW image of an iToF sensor 32 from detected values of an IR image.

FIG. 45 is a figure depicting a configuration example of a learning device used for learning by an artificial intelligence model for image recognition accuracy enhancement.

FIG. 46 is a figure depicting another configuration example of a learning device used for learning by an artificial intelligence model for image recognition accuracy enhancement.

### DESCRIPTION OF EMBODIMENTS

Hereinbelow, embodiments according to the present technology are explained in the following order with reference to the attached figures.
<0. Overview of Embodiments>
<1. First Embodiment>
(1-1. First Example)
(1-2. Second Example)
(1-3. Third Example)
(1-4. Fourth Example)
(1-5. Fifth Example)
(1-6. Sixth Example)
(1-7. Seventh Example)
<2. Second Embodiment>
(2-1. First Example)
(2-2. Second Example)
(2-3. Third Example)
(2-4. Fourth Example)
3. Third Embodiment
<4. Modification Example>
<5. About Program>
<6. Summary of Embodiments>
<7. Present Technology>

### 0. Overview of Embodiments

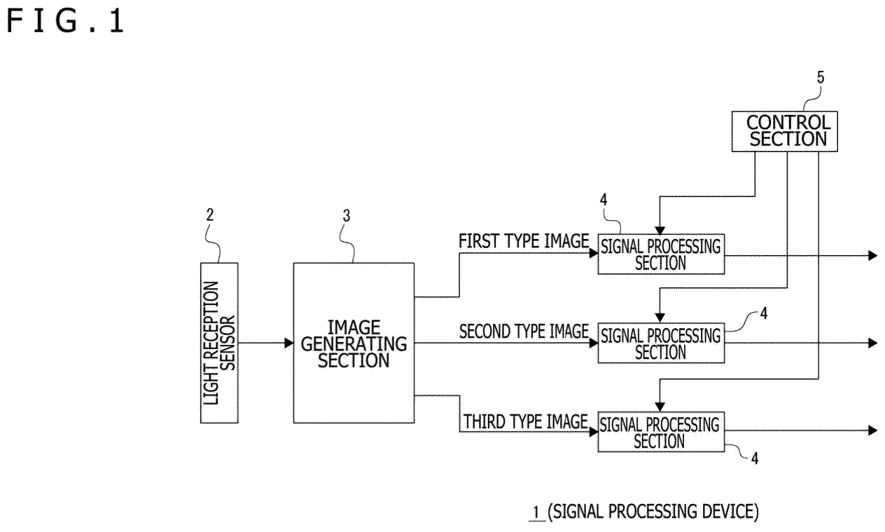

First, the concept of a signal processing device 1 as an embodiment according to the present technology is explained with reference to a block diagram in FIG. 1.

As depicted in FIG. 1, the signal processing device 1 according to the embodiment includes a light reception sensor 2, an image generating section 3, signal processing sections 4, and a control section 5.

The light reception sensor 2 is a sensor in which pixels having light receiving elements are arrayed two-dimensionally.

The image generating section 3 generates multiple types of images on the basis of an output of the light reception sensor 2. Whereas three types of images, a first type image, a second type image, and a third type image, are generated as the multiple types of images in an example in FIG. 1, the number of images to be generated by the image generating section 3 on the basis of an output of the light reception sensor 2 is not limited to three, and it is sufficient if the number is equal to or greater than at least two.

In each embodiment to be explained below, a polarization sensor (12), a spectral sensor (22), and an iToF indirect ToF (TOF: Time Of Flight) sensor (32) are illustrated as examples of the light reception sensor 2. In a case where the light reception sensor 2 is a polarization sensor, multiple types of polarization image such as, for example, a polarization component image, a reflection-removed image, or a reflection-enhanced image are generated on the basis of an output of the sensor in some cases, in order to obtain various kinds of polarization information. In addition, in a case where the light reception sensor 2 is a spectral sensor, multiple types of images are generated as narrow-band images on the basis of an output of the sensor. In a case where the light reception sensor 2 is an iToF sensor, multiple types of images are generated in some cases, as in a case where an IR (infrared) image is generated along with a distance image on the basis of an output of the sensor, and so on.

Note that details of various types of light reception sensors used in embodiments, and multiple types of images generated on the basis of outputs of the various types of sensor are explained later on.

The signal processing sections 4 are provided for performing signal processing on at least one target image in the multiple types of images generated by the image generating section 3. In configuration illustrated here, the three signal processing sections 4 are provided corresponding to generation of the three types of images, and each signal processing section 4 performs signal processing on a different image in the three types of images.

For example, examples of the signal processing performed by the signal processing sections 4 include a digital gain adjustment process for brightness adjustment or white balance adjustment of an image, and the like.

Note that it is sufficient if the signal processing device 1 according to the embodiment adopts configuration in which the signal processing is performed on at least one image in the multiple types of images generated by the image generating section 3.

The control section 5 controls signal processing parameters of the signal processing sections such that the modes of the multiple types of images generated by the image generating section 3 become appropriate.

In a case where multiple types of images are generated on the basis of an output of the light reception sensor 2, differences in characteristics are generated between the respective images due to the differences in type. For example, brightness varies by image even if the same subject is captured, and so on.

For example, if signal processing such as brightness adjustment is performed prioritizing any of multiple types of images in such a case, there is a risk that appropriate image acquisition cannot be performed for reasons such as that the brightness of other images does not become appropriate.

Because of this, the control section 5 is provided, and the signal processing parameters of the signal processing sections are controlled such that the modes of the multiple types of images become appropriate. Thereby, it is possible to attempt to acquire appropriate images in a case where multiple types of images are generated on the basis of an output of the light reception sensor 2.

### 1. First Embodiment

### 1-1. First Example

In a first embodiment, a polarization sensor 12 is used as the light reception sensor 2.

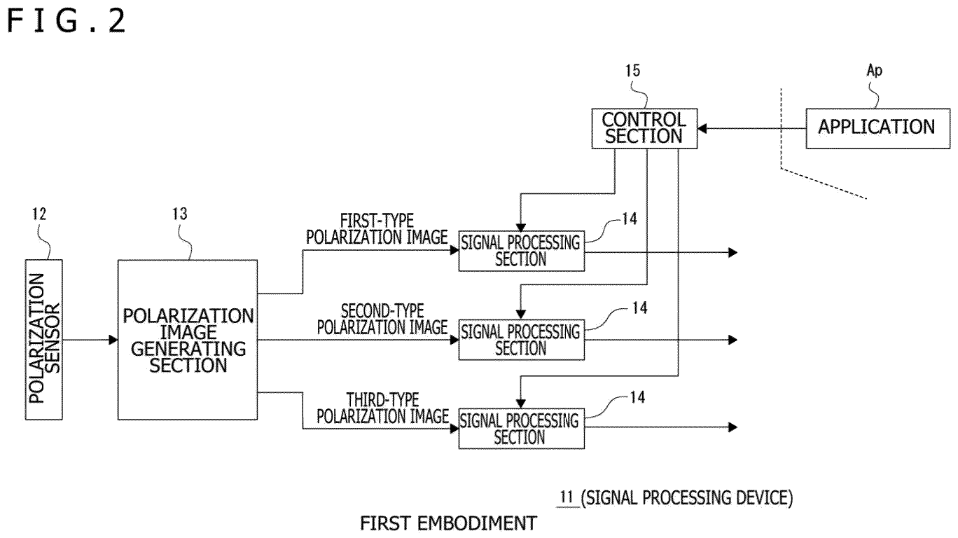

FIG. 2 is a block diagram for explaining a configuration example of a signal processing device 11 as a first example in the first embodiment.

As depicted in the figure, the signal processing device 11 includes the polarization sensor 12, a polarization image generating section 13, multiple signal processing sections 14, and a control section 15.

An application Ap depicted in the figure conceptually represents a computer device that executes an application program for receiving and processing an input of at least one of multiple types of images generated at the signal processing device 11.

The application Ap may be configured integrally with the signal processing device 11, or may be configured separately from the signal processing device 11.

The polarization sensor 12 is a light reception sensor for obtaining polarization images which are images representing polarization information for each pixel.

The polarization image generating section 13 generates the polarization images on the basis of an output of the polarization sensor 12. Specifically, the polarization image generating section 13 in the present example generates multiple types of polarization image on the basis of an output of the polarization sensor 12.

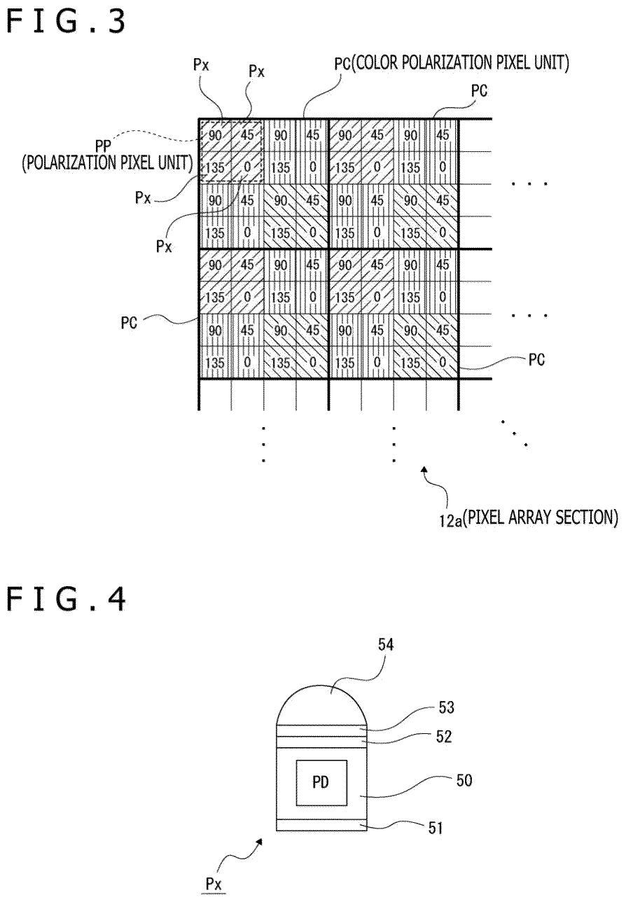

Here, the polarization sensor 12 and the polarization image generating section 13 are explained with reference to FIG. 3 to FIG. 8.

FIG. 3 is a figure schematically depicting a configuration example of a pixel array section 12a of the polarization sensor 12. The pixel array section 12a is formed by two-dimensionally arraying pixels having light receiving elements, specifically photodiodes PD in the present example.

As depicted in the figure, polarization pixel units PP and color polarization pixel units PC are formed in the pixel array section 12a.

Each polarization pixel unit PP is a pixel unit in which multiple types of pixel Px that selectively receive light with mutually different polarization angles are two-dimensionally arrayed in a predetermined pattern. Specifically, each polarization pixel unit PP in the present example includes four pixels in total which are a pixel Px that receives only light with a polarization angle of 90 degrees, a pixel Px that receives only light with a polarization angle of 45 degrees, a pixel Px that receives only light with a polarization angle of 135 degrees, and a pixel Px that receives only light with a polarization angle of 0 degrees (180 degrees), and the pixels are two-dimensionally arrayed in a predetermined pattern.

Each color polarization pixel unit PC is a pixel unit in which multiple types of polarization pixel unit PP that selectively receive light with mutually different colors are two-dimensionally arrayed in a predetermined pattern.

Specifically, each color polarization pixel unit PC in the present example includes four polarization pixel units PP in total which are one polarization pixel unit PP that receives only R light (red light), two polarization pixel units PP that receive only G light (green light), and a polarization pixel unit PP that receives only B light (blue light), and the polarization pixel units PP are two-dimensionally arrayed in a predetermined pattern.

In the figure, each polarization pixel unit PP that selectively receives R light is depicted with diagonal lines sloping down leftward, each polarization pixel unit PP that selectively receives G light is depicted with vertical lines, and each polarization pixel unit PP that selectively receives B light is depicted with diagonal lines sloping down rightward.

Each color polarization pixel unit PC in the present example includes four polarization pixel units PP that receive R light, B light, and G light, and arrayed in a Bayer (Bayer) type.

The pixel array section 12a includes the color polarization pixel units PC like the ones described above that are arrayed two-dimensionally. That is, the multiple color polarization pixel units PC are arrayed in both a vertical direction (column direction) and a horizontal direction (row direction).

It becomes possible to generate a color image of each of R, G, and B as various types of polarization image due to the configuration of the pixel array section 12a like the one described above. That is, it becomes possible to generate color images as various types of polarization image.

In the pixel array section 12a, each pixel Px is configured to be capable of selectively receiving light with a predetermined polarization angle, and selectively receiving light with a predetermined color (in a predetermined wavelength band).

FIG. 4 illustrates a schematic cross-sectional structure of a pixel Px.

As depicted in the figure, the pixel Px has a photodiode PD as a light receiving element formed in a semiconductor substrate 50, has a wiring layer 51 formed on one surface side of the semiconductor substrate 50, and has a polarization filter 52, a color filter 53, and a microlens 54 that are stacked on the other surface side of the semiconductor substrate 50.

The polarization filter 52 has a polarizer that selectively transmits linearly polarized light that vibrates in a particular direction (angle). For example, examples of the polarizer include one that uses a wire grid, and one having a crystalline structure such as a photonic crystal.

The color filter 53 is configured as an optical bandpass filter that selectively transmits light in a predetermined wavelength band. For example, an optical bandpass filter that selectively transmits R light is formed as a color filter 53 in a pixel Px that receives R light. In addition, an optical bandpass filter that selectively transmits G light, and an optical bandpass filter that selectively transmits B light are formed as color filters 53, respectively, in a pixel Px that receives G light, and a pixel Px that receives B light.

Note that a relation between the polarization filter 52 and the color filter 53 in terms of vertical arrangement positions may be reversed.

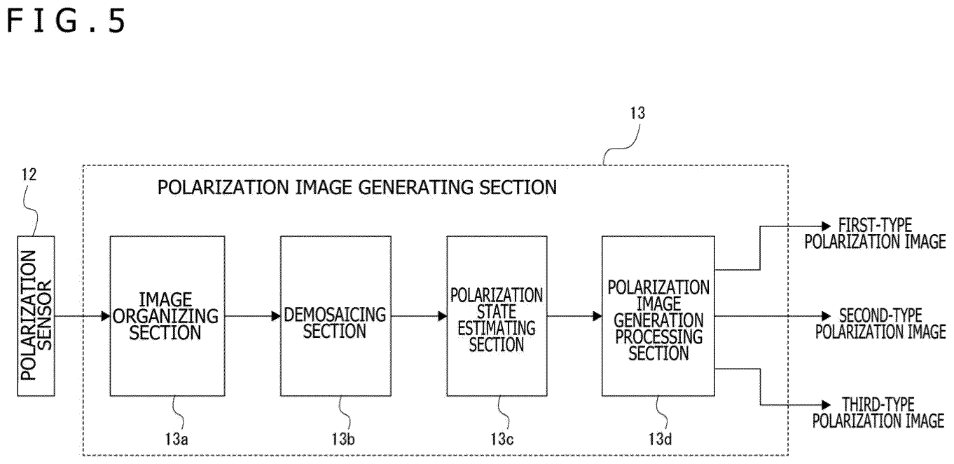

FIG. 5 is a block diagram for explaining an internal configuration example of the polarization image generating section 13.

As depicted in the figure, the polarization image generating section 13 has an image organizing section 13a, a demosaicing section 13b, a polarization state estimating section 13c, and a polarization image generation processing section 13d.

By an image organization process performed by the image organizing section 13a, and a demosaicing process performed by the demosaicing section 13b, a color image of each of R, G, and B is obtained for each of an image obtained by selectively receiving light with a polarization angle of 90 degrees (hereinafter, written as a “90-degree image”), an image obtained by selectively receiving light with a polarization angle of 45 degrees (hereinafter, written as a “45-degree image”), an image obtained by selectively receiving light with a polarization angle of 0 degrees (hereinafter, written as a “0-degree image”), and an image obtained by selectively receiving light with a polarization angle of 135 degrees (hereinafter, written as a “135-degree image”).

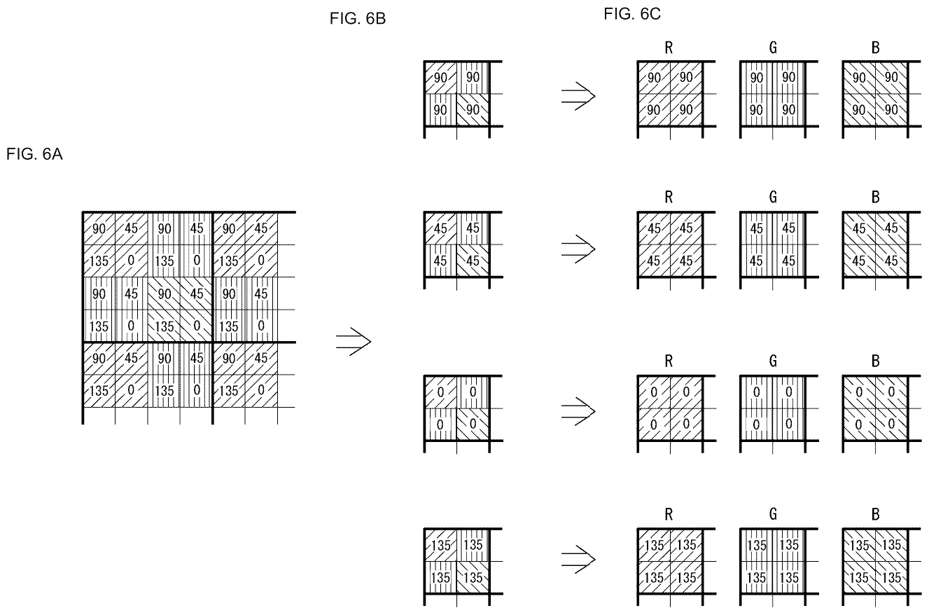

FIG. 6 is a figure for explaining the image organization process performed by the image organizing section 13a, and the demosaicing process performed by the demosaicing section 13b.

In the image organization process, light-reception values of pixels Px that receive light with the same polarization angle are extracted from a RAW image (see FIG. 6A) output from the polarization sensor 12, and a polarization angle separation image which is an image for each polarization angle is organized (see FIG. 6B).

By performing such an image organization process, four pixels in total which are one pixel that receives R light, two pixels that receive G light, and one pixel that receives B light are Bayer-arrayed for each of the polarization angle separation images of the polarization angles of 90 degrees, 45 degrees, 0 degrees, and 135 degrees of each color polarization pixel unit PC. That is, it becomes possible to apply a typical demosaicing process on Bayer arrays.

The demosaicing section 13b implements the demosaicing process on each polarization angle separation image. By such a demosaicing process, as depicted in FIG. 6C, color images of each of R, G, and B are obtained as a 90-degree image, a 45-degree image, a 0-degree image, and a 135-degree image.

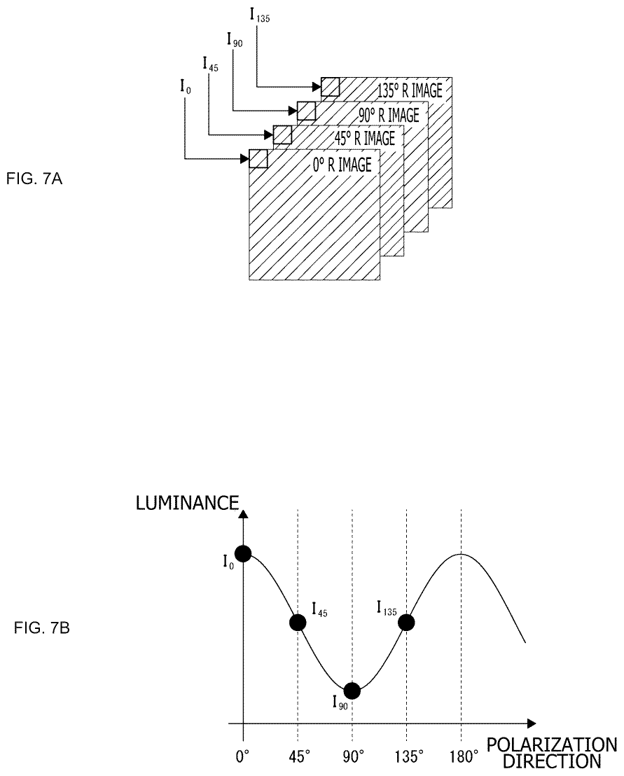

FIG. 7 is a figure for explaining a process performed by the polarization state estimating section 13c.

FIG. 7A representatively depicts a 90-degree image, a 45-degree image, a 0-degree image, and a 135-degree image as R images in the 90-degree images, the 45-degree images, the 0-degree images, and the 135-degree images of the respective colors obtained by the demosaicing section 13b.

The polarization state estimating section 13c performs a process of performing fitting to a sine wave like the one depicted in FIG. 7B for each pixel position of a color image of each of R, G, and B on the basis of the 90-degree image, the 45-degree image, the 0-degree image, and the 135-degree image of each color obtained by the demosaicing section 13b.

The polarization state of incident light is expressed by a sine wave representing the luminance along a vertical axis, and the polarization direction (polarization angle) along a horizontal axis. Accordingly, by performing, for each pixel position, fitting based on a light-reception value (luminance value) of each of the 90-degree image, the 45-degree image, the 0-degree image, and the 135-degree image of each target color onto the sine wave, the polarization state of each pixel position can be estimated.

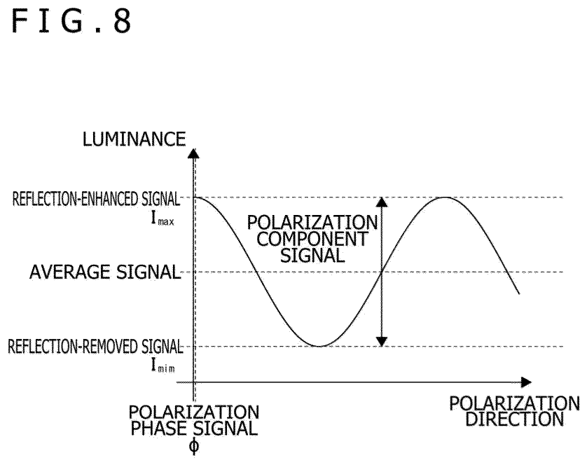

FIG. 8 is a figure for explaining an approach to generating various types of polarization image performed by the polarization image generation processing section 13d.

Since information regarding the sine wave representing the polarization state of each pixel position is determined by the polarization state estimating section 13c, it becomes possible to generate various types of polarization image on the basis of the information regarding the sine wave.

Here, as examples of polarization images, a reflection-enhanced image, a polarization component image, a reflection-removed image, and an average image are illustrated. The reflection-enhanced image is an image obtained by sensing a reflection-enhanced signal for each pixel position. As depicted in the figure, the reflection-enhanced signal is sensed as the maximum value (Imax) of the sine wave. That is, the reflection-enhanced image is generated by sensing the maximum value of the sine wave for each pixel position.

In addition, the reflection-removed image is an image obtained by sensing a reflection-removed signal for each pixel position. As depicted in the figure, the reflection-removed signal is sensed as the minimum value (Imin) of the sine wave. Accordingly, the reflection-removed image can be generated by sensing the minimum value of the sine wave for each pixel position.

The polarization component image is an image obtained by sensing a polarization component signal for each pixel position. As depicted in the figure, the polarization component signal is calculated as the difference value (“Imax-Imin”) between the maximum value and the minimum value of the sine wave. Accordingly, the polarization component image can be generated by calculating the difference value between the maximum value and the minimum value of the sine wave for each pixel position.

The average image is an image obtained by sensing the average signal of the sine wave for each pixel position. Accordingly, the average image can be generated by calculating the average of the sine wave for each pixel position.

Note that various signals representing polarization states of incident light can be generated from the information regarding the sine wave representing the polarization states, and polarization images that can be generated by the polarization image generation processing section 13d are not limited to the four types, the reflection-enhanced images, the polarization component images, the reflection-removed images, and the average image, that are illustrated in the description above.

It is assumed in the present example that the polarization image generation processing section 13d is configured to generate and output three types of polarization image as polarization images. These three types of polarization image are written as a first-type polarization image, a second-type polarization image, and a third-type polarization image (see FIG. 2 and FIG. 5).

The explanation is continued with reference to FIG. 2 again.

In the signal processing device 11, each of three signal processing sections 14 in total is provided for one polarization image of the first-type polarization image, the second-type polarization image, and the third-type polarization image.

In the present example, each signal processing section 14 is configured to be capable of adjusting the brightness of an input image by performing the digital gain adjustment process on the input image.

For example, the control section 15 includes a microcomputer having a CPU (Central Processing Unit), a ROM (Read Only Memory), a RAM (Random Access Memory), and the like, and controls an operation by the signal processing device 1.

Specifically, the control section 15 in the present example controls signal processing parameters of the digital gain adjustment process in each signal processing section 14 on the basis of an instruction from the application Ap.

For example, in a case where a reflection-enhanced image and a reflection-removed image in various types of polarization image are compared, the former tends to be a relatively bright image, and, on the other hand, the latter tends to be a relatively darkish image. For example, as in a relation between these reflection-enhanced image and reflection-removed image, differences in brightness caused by the differences in image type are generated between different types of polarization image. In view of this, in the present example, the application Ap gives an instruction to the control section 15 about signal processing parameters (signal processing parameters of the digital gain adjustment process) for negating the differences in brightness between the polarization images, and the control section 15 sets the thus-instructed signal processing parameters for the respective corresponding signal processing sections 14.

Thereby, it becomes possible to perform signal processing on polarization images such that the brightness of each polarization image becomes appropriate in a case where multiple types of polarization image include at least one polarization image with brightness which is different from the brightness of other polarization images.

Accordingly, it is possible to attempt to acquire appropriate polarization images.

Note that whereas a signal processing section 14 is provided for each polarization image in the example in the description above, it is possible also to adopt configuration in which one signal processing section 14 performs signal processing on each polarization image in a time division manner.

In this case, it is possible that the polarization image generating section 13 generates multiple types (in the present example, three types) of polarization image from an input image of one frame from the polarization sensor 12, and, in each frame period, one type of the generated multiple types of polarization image is output to the signal processing section 14.

Alternatively, it is possible also that the polarization image generating section 13 repeats an operation to generate only one type of polarization image from an input image of one frame from the polarization sensor 12, and output the generated one type of polarization image to the signal processing section 14 a number of times which is equal to the number of types of polarization images that should be generated.

### 1-2. Second Example

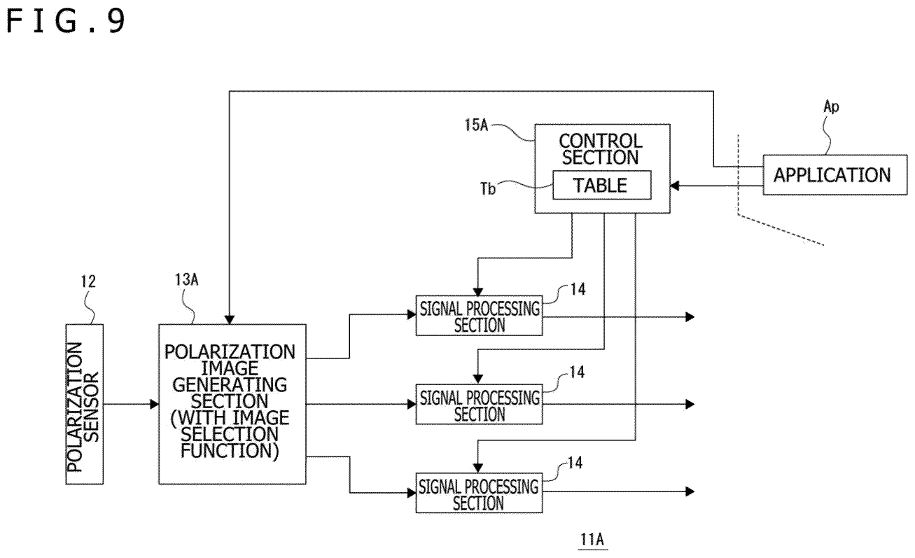

Subsequently, a signal processing device 11A as a second example in the first embodiment is explained with reference to a block diagram in FIG. 9.

The second example is an example in which it is made possible to make a selection as to which polarization images are to be output as multiple polarization images, and signal processing parameters corresponding to the selected polarization images are set.

Note that, in the following explanation, portions that are similar to portions that have already been explained are given identical reference signs, and explanations thereof are omitted.

As can be known by comparison with FIG. 2 mentioned earlier, the signal processing device 11A is different from the signal processing device 11 in that the signal processing device 11A is provided with a polarization image generating section 13A instead of the polarization image generating section 13, and is provided with a control section 15A instead of the control section 15.

The polarization image generating section 13A is different from the polarization image generating section 13 in that the polarization image generating section 13A has a function to generate and output polarization images that the polarization image generating section 13A is externally (in the present example, by the application Ap) instructed to generate and output, in multiple polarization images that can be generated (image selection function).

The control section 15A sets signal processing parameters of each signal processing section 14 on the basis of image selection information from the application Ap, that is, information representing which polarization images the polarization image generating section 13A is instructed to generate/output.

In this case, the control section 15A has stored thereon a table Tb in which signal processing parameters that should be set corresponding to each polarization image that can be generated by the polarization image generating section 13A are associated with the polarization image. The control section 15A performs a process of identifying signal processing parameters that should be set for each signal processing section 14, and setting the identified signal processing parameters for the corresponding signal processing section 14, on the basis of the image selection information from the application Ap, and information stored as the table Tb.

Thereby, coping with a case where the polarization image generating section 13A has the image selection function, it is possible to perform signal processing such that the brightness of each polarization image becomes appropriate.

Note that whereas the image selection information is notified from the application Ap to the control section 15A in the example in the description above, configuration in which the polarization image generating section 13A notifies the control section 15A of the image selection information can also be adopted.

### 1-3. Third Example

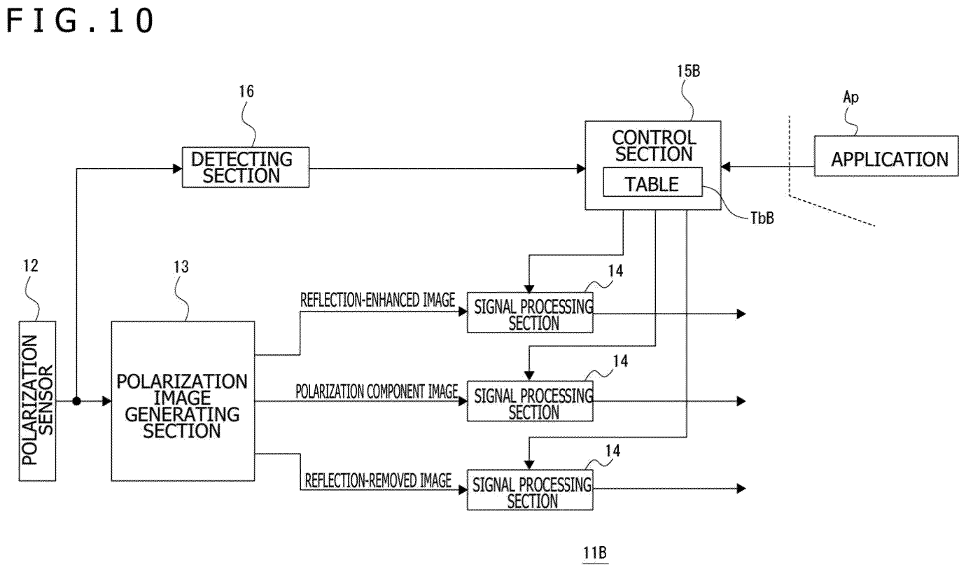

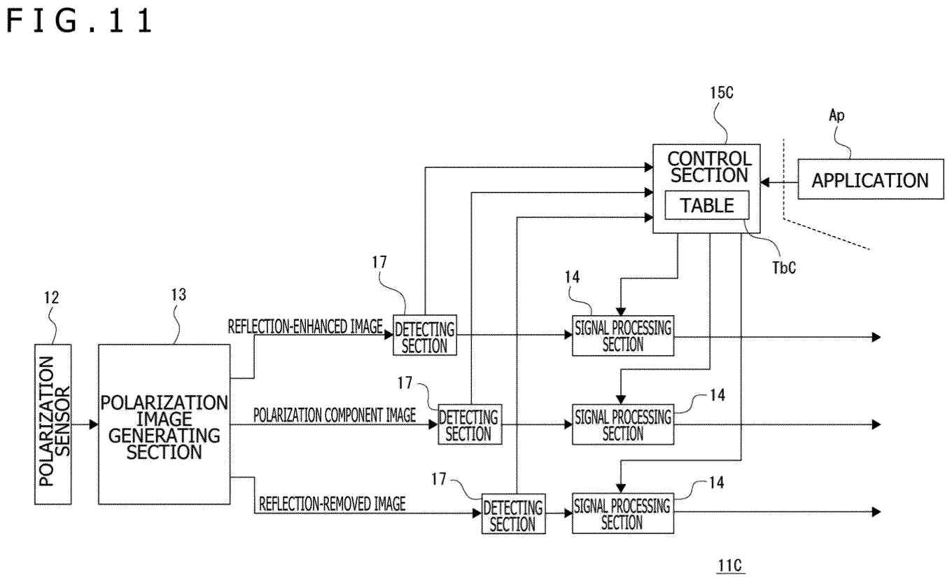

FIG. 10 is a block diagram for explaining a configuration example of a signal processing device 11B as a third example in the first embodiment.

The third example is an example in which signal processing parameters are changed dynamically on the basis of detected values of a RAW image.

Here, the RAW image means an output image of the light reception sensor 2, and, in the present example, means an output image of the polarization sensor 12 (see FIG. 6A).

The signal processing device 11B is different from the signal processing device 11 in that the signal processing device 11B additionally has a detecting section 16, and is provided with a control section 15B instead of the control section 15. Here, it is supposed in the following explanation that images generated/output by the polarization image generating section 13 are three types, which are a reflection-enhanced image, a polarization component image, and a reflection-removed image.

The detecting section 16 performs detection on the RAW image output by the polarization sensor 12. Specifically, the detecting section 16 performs detection (sensing) of luminance values. The detection mentioned here is performed for each pixel position.

The control section 15B controls signal processing parameters of each signal processing section 14 dynamically depending on the brightness of the RAW image on the basis of detected values of the RAW image input from the detecting section 16, and a table TbB.

The table TbB has stored thereon, for each polarization image of a reflection-enhanced image, a polarization component image, and a reflection-removed image, correspondence information representing the correspondence between the brightness of a RAW image (the levels of detected values) and signal processing parameters that should be set. This is on the assumption that, for example, in some cases, signal processing parameters that should be set vary depending on whether each polarization image is that of a bright scene or a dark scene.

The control section 15B performs a process of identifying signal processing parameters that should be set depending on the brightness of a RAW image on the basis of detected values of the RAW image from the detecting section 16, and the table TbB, and setting the identified signal processing parameters for the respective corresponding signal processing sections 14.

For example, it is possible that this process is executed repeatedly at predetermined intervals such as for each frame. Alternatively, it is possible also that change amounts of brightness are sensed on the basis of detected values of a RAW image or the like, and the process is executed when a change amount becomes equal to or greater than a predetermined amount, and so on. Alternatively, it is possible also that the process is executed on the basis of an instruction from the application Ap, and so on.

### 1-4. Fourth Example

FIG. 11 is a block diagram for explaining a configuration example of a signal processing device 11C as a fourth example in the first embodiment.

The fourth example is an example in which detection is performed for each polarization image, and signal processing parameters of each polarization image are controlled on the basis of detection results.

The signal processing device 11C is different from the signal processing device 11 in that the signal processing device 11C additionally has a detecting section 17 for each polarization image, and is provided with a control section 15C instead of the control section 15.

Each detecting section 17 performs detection for a polarization image output from the polarization image generating section 13, and input to a corresponding signal processing section 14.

The control section 15C controls signal processing parameters of each signal processing section 14 dynamically on the basis of detected values from a detecting section 17, that is, detected values of a polarization image, and a table TbC.

In this case, the table TbC has stored thereon, for each polarization image of a reflection-enhanced image, a polarization component image, and a reflection-removed image, correspondence information representing the correspondence between the levels of detected values of the polarization image and signal processing parameters that should be set.

The control section 15C performs a process of identifying signal processing parameters that should be set for each polarization image on the basis of detected values of each polarization image input from a detecting section 17, and the table TbC, and setting the identified signal processing parameters for the respective corresponding signal processing sections 14.

Thereby, the brightness of each polarization image can be controlled dynamically on the basis of the detected values.

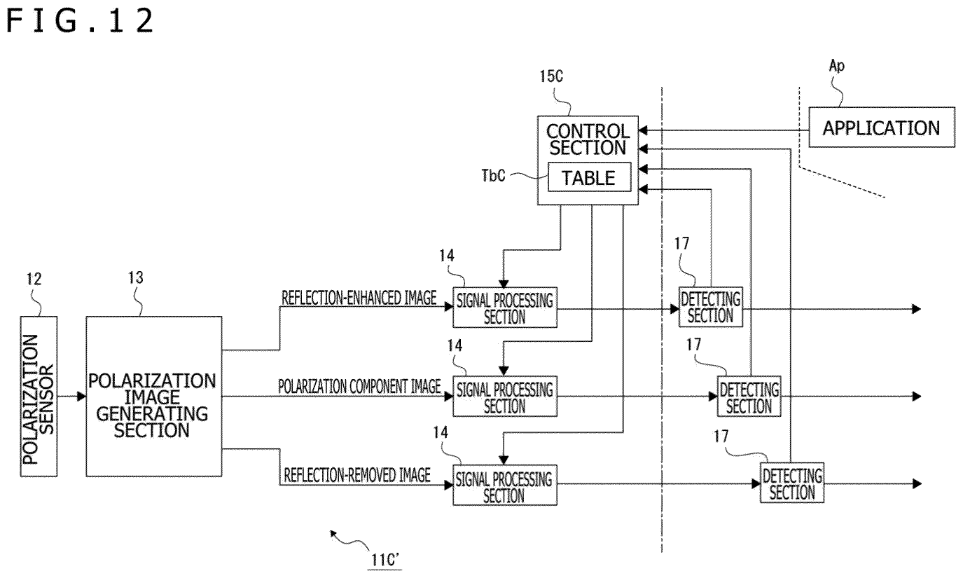

Note that whereas the detecting sections 17 are arranged upstream of the signal processing sections 14 in the example in the description above, as depicted in FIG. 12, each detecting section 17 can also be arranged downstream of a corresponding signal processing section 14.

In this case, the control of signal processing parameters of each signal processing section 14 by the control section 15C is performed on the basis of detected values of a polarization image of the previous frame.

Here, the polarization image generating section 13, each signal processing section 14, and the control section 15C can also be formed in a single semiconductor package along with the polarization sensor 12. For example, in one configuration example, electronic circuits as the polarization image generating section 13, each signal processing section 14, and the control section 15C are formed on the wiring layer 51 stacked on the semiconductor substrate 50 where the pixel array section 12a is formed, and the polarization sensor 12, the polarization image generating section 13, each signal processing section 14, and the control section 15C are formed as an integrated device. A device in which the polarization sensor 12, the polarization image generating section 13, each signal processing section 14, and the control section 15C are integrated in this manner is written as a signal processing device 11C′.

In a case where each detecting section 17 is arranged downstream of a corresponding signal processing section 14 as described above, the detecting sections 17 can be arranged outside the signal processing device 11C′.

### 1-5. Fifth Example

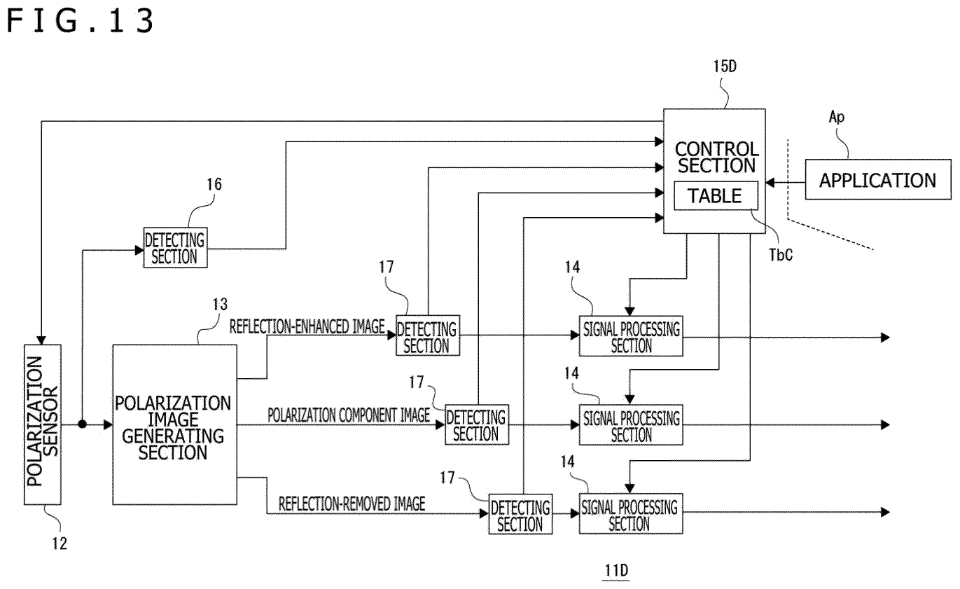

FIG. 13 is a block diagram for explaining a configuration example of a signal processing device 11D as a fifth example in the first embodiment.

In the fifth example, while control to adjust the brightness of each polarization image dynamically on the basis of detected values of the polarization image is performed as in the fourth example, exposure adjustment (light reception period adjustment) of the polarization sensor 12 based on detected values of a RAW image is performed.

The signal processing device 11D is different from the signal processing device 11C in the fourth example in that the signal processing device 11D additionally has the detecting section 16 that performs detection of a RAW image, and is provided with a control section 15D instead of the control section 15C.

Similarly to the control section 15C, the control section 15D has a function to control signal processing parameters of each polarization image dynamically on the basis of detected values of each detecting section 17 and the table TbC.

In addition to the function, the control section 15D has a function to control the exposure of the polarization sensor 12 on the basis of detected values of a RAW image input from the detecting section 16.

Specifically, the control section 15D identifies an exposure setting value according to the detected values input from the detecting section 16 on the basis of correspondence information (e.g., which is preset on the control section 15D) representing the correspondence between detected values of RAW images and exposure setting values of the polarization sensor 12, and performs control such that exposure adjustment of the polarization sensor 12 is performed on the basis of the identified exposure setting value.

Thereby, the exposure adjustment of the polarization sensor 12 can be performed such that flared highlights or blocked up shadows are not generated in a RAW image. That is, AE (Auto Exposure) control based on the brightness of the RAW image as reference brightness can be realized.

Here, it is not guaranteed that appropriate AE control is necessarily performed for each polarization image even if the AE control based on a RAW image as a reference image is performed as described above. In view of this, it is assumed that, in the signal processing device 11D, detection of each polarization image is performed, and, on the basis of results of the detection, brightness adjustment (digital gain adjustment) of each polarization image is performed by a corresponding signal processing section 14. Thereby, it is possible to attempt to make the brightness of each polarization image appropriate while making use of the AE function using a RAW image as a reference image.

### 1-6. Sixth Example

A sixth example is an example in which detected values of a target image are inferred from detected values of another image (another type of image).

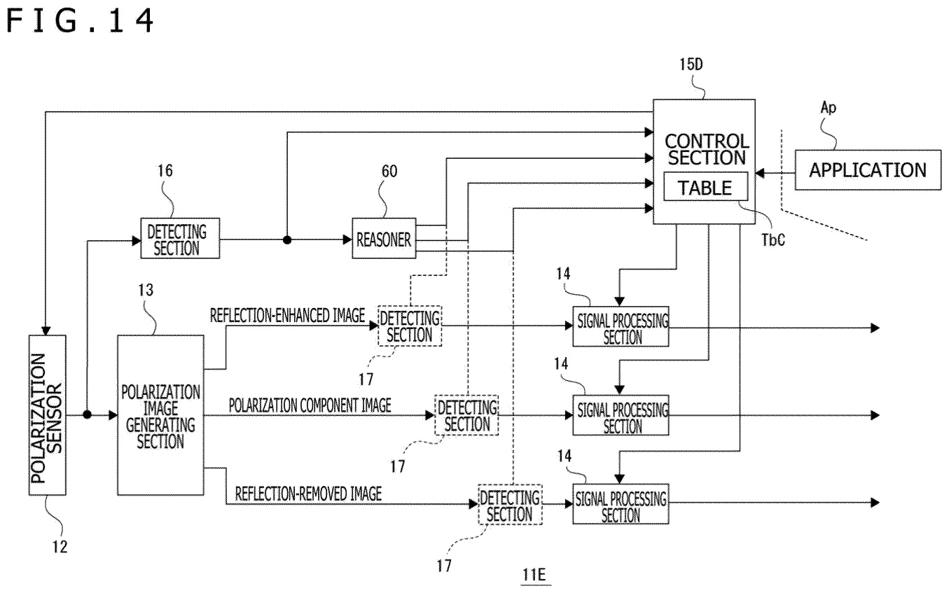

FIG. 14 is a block diagram for explaining a configuration example of a signal processing device 11E as a sixth example.

The signal processing device 11E includes a reasoner 60 that infers detected values of each polarization image from detected values of a RAW image obtained by the detecting section 16. The inference here means inference using an artificial intelligence model generated by machine learning.

As depicted in the figure, the control section 15D in this case receives inputs of detected values of a RAW image obtained by the detecting section 16, and detected values of each polarization image inferred by the reasoner 60.

With configuration like the one described above, it is possible to omit a detecting section 17 for each polarization image in realizing the AE function and dynamic digital gain adjustment process for each polarization image explained as the fifth example. That is, it is possible to attempt to reduce the number of parts, and to attempt to reduce the size of the signal processing device 11E.

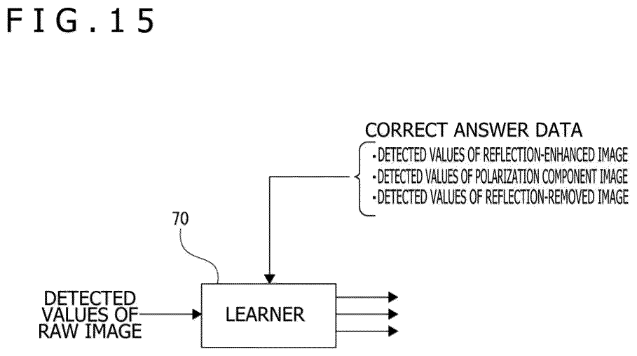

The artificial intelligence model applied to the reasoner 60 is generated by machine learning using a learner 70 like the one depicted in FIG. 15, for example.

The learner 70 performs machine learning using detected values of RAW image as training input data, and using detected values of inference-target polarization images, that is, in the present example, detected values of reflection-enhanced images, detected values of polarization component images, and detected values of reflection-removed images, as correct answer data. For example, machine learning as deep learning using a DNN (Deep Neural Network) is performed.

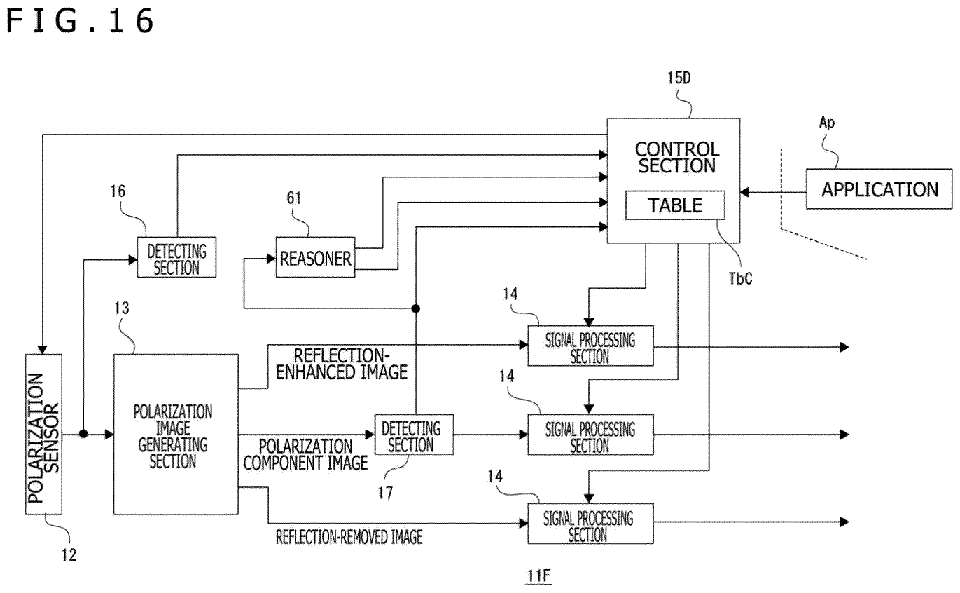

The artificial intelligence model obtained by performing such machine learning is applied as the artificial intelligence model of the reasoner 60.

Whereas the reasoner 60 that infers detected values of each polarization image from detected values of a RAW image is used in the example in the description above, for example, as in a signal processing device 11F depicted in FIG. 16, a reasoner 61 that infers, from detected values of one polarization image, detected values of other polarization images can also be used.

Specifically, the reasoner 61 here infers detected values of each of a reflection-enhanced image and a reflection-removed image from detected values of a polarization component image obtained by a detecting section 17.

In this case, the control section 15D receives inputs of detected values of a RAW image obtained by the detecting section 16, detected values of a polarization component image sensed by the detecting section 17, detected values of a reflection-enhanced image inferred by the reasoner 61, and detected values of a reflection-removed image inferred by the reasoner 61. In this configuration, it is possible to omit two detecting sections 17 from the configuration of the signal processing device 11D in the fifth example.

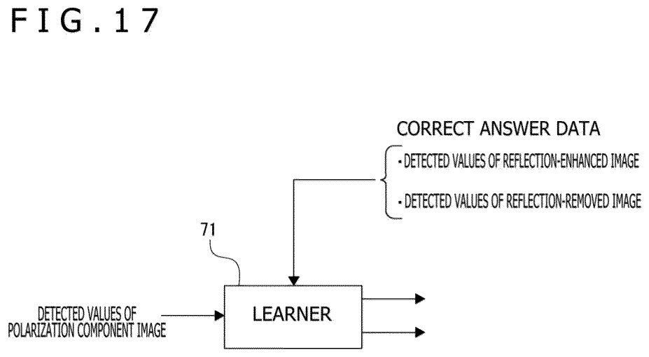

An artificial intelligence model applied to the reasoner 61 is generated by machine learning using a learner 71 like the one depicted in FIG. 17, for example.

The learner 71 performs machine learning (e.g., deep learning using a DNN) using detected values of polarization component images as training input data, and using detected values of inference-target reflection-enhanced images, and detected values of inference-target reflection-removed images as correct answer data.

The artificial intelligence model obtained by performing such machine learning is applied as the artificial intelligence model of the reasoner 61.

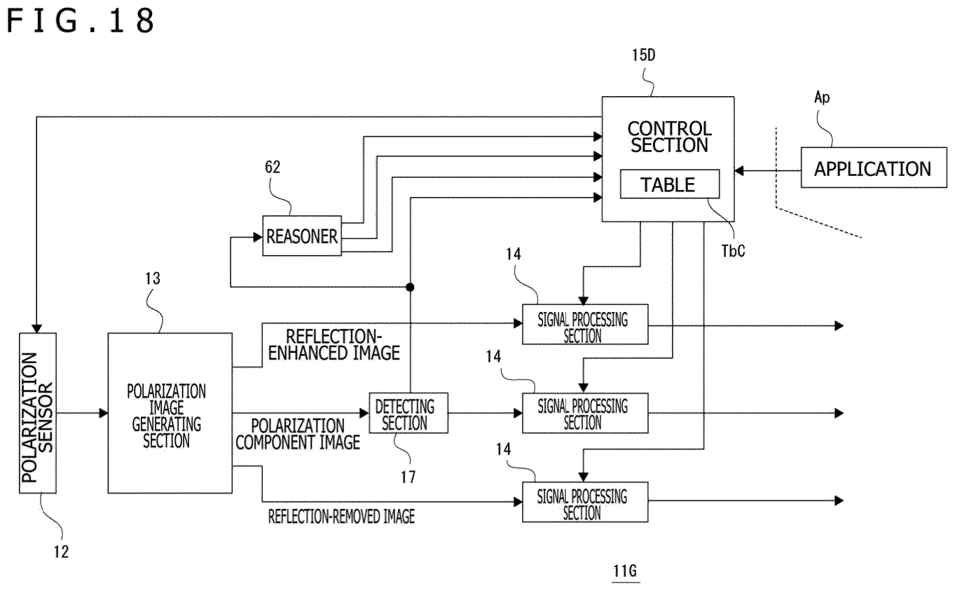

Alternatively, as in a signal processing device 11G depicted in FIG. 18, a reasoner 62 that infers detected values of a RAW image from detected values of a polarization image can also be used. Here, from detected values of one polarization image, specifically detected values of a polarization component image, the reasoner 62 infers detected values of a RAW image, and detected values of other polarization images (a reflection-enhanced image and a reflection-removed image).

In this case, the control section 15D receives inputs of detected values of a RAW image inferred by the reasoner 62, detected values of a reflection-enhanced image inferred by the reasoner 62, detected values of a reflection-removed image inferred by the reasoner 62, and detected values of a polarization component image sensed by a detecting section 17. In this configuration, it is possible to omit the detecting section 16 and two detecting sections 17 from the configuration of the signal processing device 11D in the fifth example.

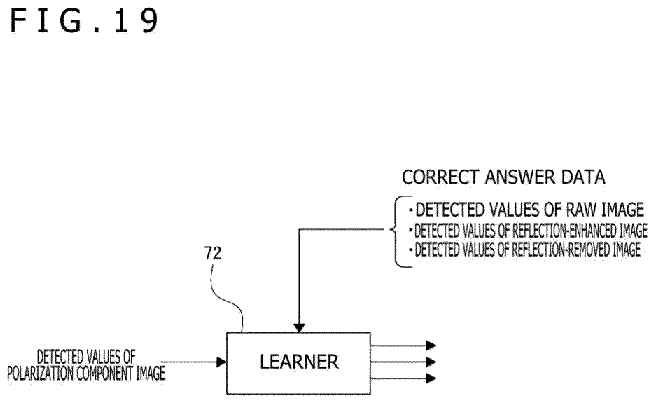

An artificial intelligence model applied to the reasoner 62 is generated by machine learning using a learner 72 like the one depicted in FIG. 19, for example.

The learner 72 performs machine learning (e.g., deep learning using a DNN) using detected values of polarization component images as training input data, and using detected values of inference-target RAW images, detected values of inference-target reflection-enhanced images, and detected values of inference-target reflection-removed images as correct answer data.

The artificial intelligence model obtained by performing such machine learning is applied as the artificial intelligence model of the reasoner 62.

Here, relearning can also be performed for an artificial intelligence model of a reasoner.

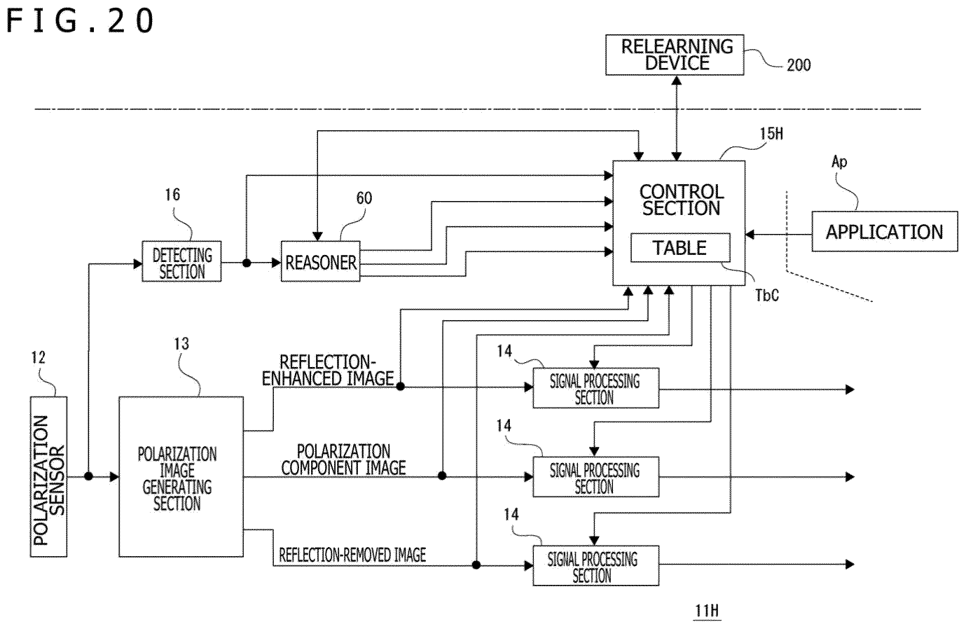

FIG. 20 is a block diagram for explaining a configuration example of a signal processing device 11H used on the assumption that relearning is performed.

Whereas the reasoner 60 is used as a reasoner that infers detected values in the example here, similar principles can be applied also in cases where other reasoners (the reasoners 61 and 62) are used.

The signal processing device 11H is different from the signal processing device 11E in the sixth example in that the signal processing device 11H is provided with a control section 15H instead of the control section 15D.

The control section 15H is configured to be capable of performing data communication with a relearning device 200 set as an external device of the signal processing device 11H.

The relearning device 200 is a device that performs a relearning process for the artificial intelligence model applied to the reasoner 60. For example, the relearning device 200 is configured as a computer device such as a cloud server, and communication with the control section 15H is performed via a communication network such as the Internet.

Although not depicted in the figure, relearning in this case is performed by using the learner 70 depicted in FIG. 15. Specifically, in the relearning in this case, machine learning by the learner 70 is executed using detected values (input data) of RAW images prepared as a dataset for relearning, and detected values (correct answer data) of each of reflection-enhanced images, polarization component images, and reflection-removed images.

The concept of the relearning of the artificial intelligence model mentioned here includes at least updating of parameters for inference in the artificial intelligence model. Note that, for example, the relearning of the artificial intelligence model may include updating of elements other than parameters for inference such as updating of the network structure of a DNN.

In addition to functions as the control section 15D mentioned before, the control section 15H has the following functions related to the relearning.

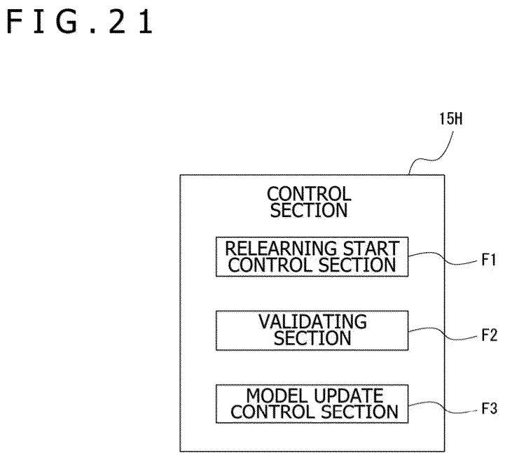

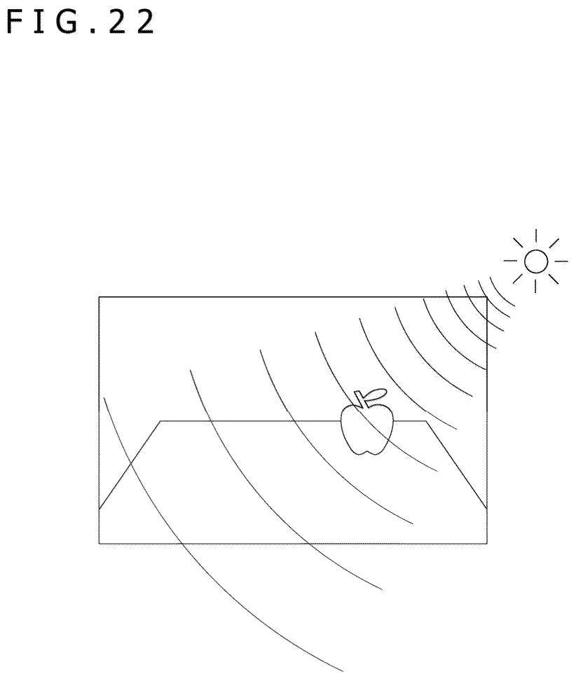

FIG. 21 is a functional block diagram for explaining functions related to the relearning that the control section 15H has.

As depicted in the figure, the control section 15H has functions as a relearning start control section F1, a validating section F2, and a model update control section F3.

The relearning start control section F1 performs control to start the relearning of the artificial intelligence model of the reasoner 60. Specifically, the relearning start control section F1 causes the relearning device 200 to start the relearning of the artificial intelligence model when a predetermined trigger condition is satisfied.

For example, examples of the trigger condition here include a condition based on temporal information (a length of time that has elapsed from the time of the previous learning, etc.), a condition based on the operation situation of an operation performed using detected values such as AE or brightness adjustment of each polarization image, a relearning execution instruction from the application Ap, and the like. Alternatively, it is possible also that, in a case where the application Ap performs a process using polarization images, the trigger condition is a condition based on an evaluation result of the process.

When causing the relearning device 200 to execute the relearning, the relearning start control section F1 in the present example supplies the relearning device 200 with detected values of RAW images that should be used as training data in the relearning, and each type of polarization image (reflection-enhanced images, polarization component images, reflection-removed images). Note that it is sufficient if, at this time, detection of each polarization image is executed on the side of the relearning device 200.

The validating section F2 evaluates (validates) results of inference performed by applying the relearning model which is an artificial intelligence model after relearning to the reasoner 60. Specifically, in response to completion of the relearning of the artificial intelligence model by the relearning device 200, the validating section F2 applies the relearning model obtained by the relearning to the reasoner 60, and causes the relearning model to infer detected values of each polarization image. Then, the validating section F2 evaluates results of the inference. For example, a predetermined evaluation value is determined.

The model update control section F3 controls application of the artificial intelligence model to the reasoner 60 on the basis of a result of the evaluation by the validating section F2.

Specifically, in a case where the validating section F2 determines, as the result of the evaluation, that inference is being performed favorably (e.g., in a case where the evaluation value is equal to or greater than a certain value), the model update control section F3 keeps the relearning model applied. That is, the relearning model is kept being used for performing subsequent inference.

On the other hand, in a case where the validating section F2 determines, as the result of the evaluation, that inference is not being performed favorably (e.g., in a case where the evaluation value is lower than the certain value), the model update control section F3 causes an artificial intelligence model other than the relearning model to be applied to the reasoner 60. For example, an artificial intelligence model that had been applied in the past, specifically an artificial intelligence model that had been applied initially, an artificial intelligence model that has been producing favorable evaluation results in past relearning, or the like, is caused to be applied.

With the functions of the control section 15H like the ones described above, it becomes possible to perform updating of the artificial intelligence model such that the artificial intelligence model produces favorable inference results in a real environment.

### 1-7. Seventh Example

A seventh example is an example in which signal processing for canceling a color cast of a light source color is performed. Here, since light from a light source is emitted onto an object in a case where, for example, image-capturing using an RGB sensor is performed, the color of a captured image of the object does not reflect the true color of the object. That is, the color of the object expressed in the RGB image is a color reflecting a light source color superimposed on the true color of the object (see FIG. 22).

In contrast to this, in a case where the polarization sensor 12 is used, it is easier to identify the true color of the object. Specifically, the true color of the object can be identified on the basis of a reflection-removed image and a polarization component image.

Reflection-removed images are images from which unwanted reflection is removed, and accordingly can be said to be images on which the color of an object can be identified easily. In addition, polarization component images are images capturing specular reflection components, and are known as representing light source colors.

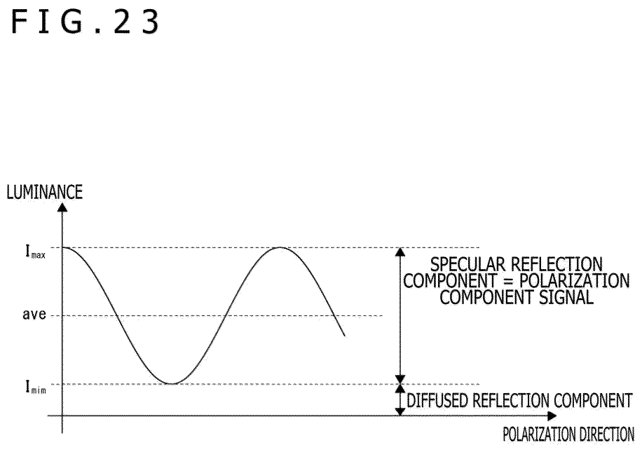

Reflection light from a subject includes diffused reflection light (diffused reflection component) and specular reflection light (specular reflection component) (see FIG. 23). Among them, the specular reflection component is a component generated by direct reflection of the color of a light source. Since the specular reflection component can be acquired as a polarization component image as depicted in the figure, it becomes possible to identify the color of the light source from a polarization component image of each color of R, G, and B by generating the polarization component image of each color of R, G, and B at the polarization image generating section 13.

By identifying the light source color from the polarization component images in this manner, and performing WB (white balance) adjustment (color balance adjustment) of canceling the light source color as WB adjustment on a reflection-removed image, the true color of the object can be identified.

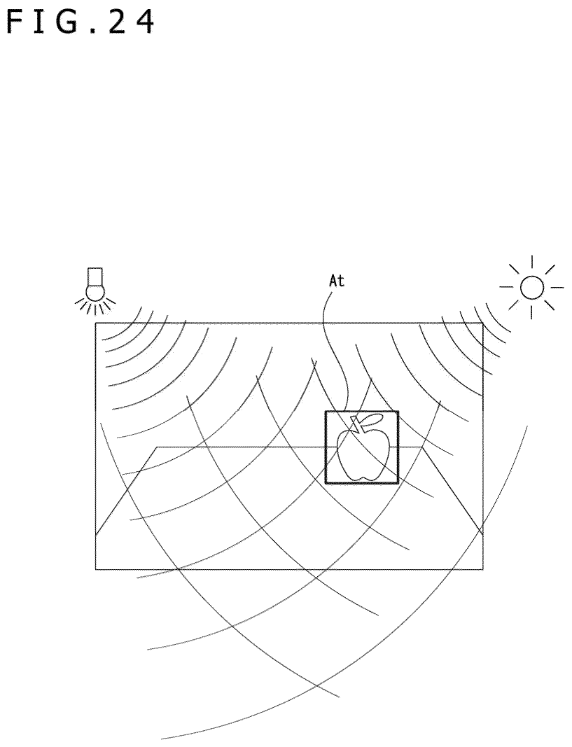

Note that, possible scenes where images of subjects are captured include a scene with a MIX light source like the one depicted in FIG. 24. Specifically, FIG. 24 illustrates a scene where light from both a light source as an illuminating device in a room and a light source as the sun is emitted to a subject.

In a case where there is a MIX light source, the MIX ratio of light source colors differs by area in an image frame, and accordingly the modes of color casts of the light source color differ by area.

In view of this, in this case, identification of light source colors is performed on an area (hereinafter, written as a “target subject area At”) where a color-identification-target subject is captured. Thereby, the true color of the target subject can be identified appropriately by appropriately canceling light source colors in the target subject area At.

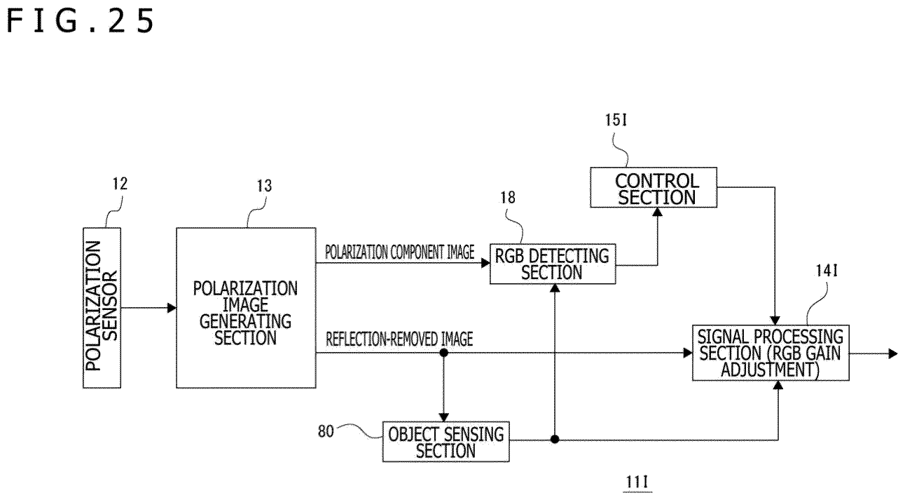

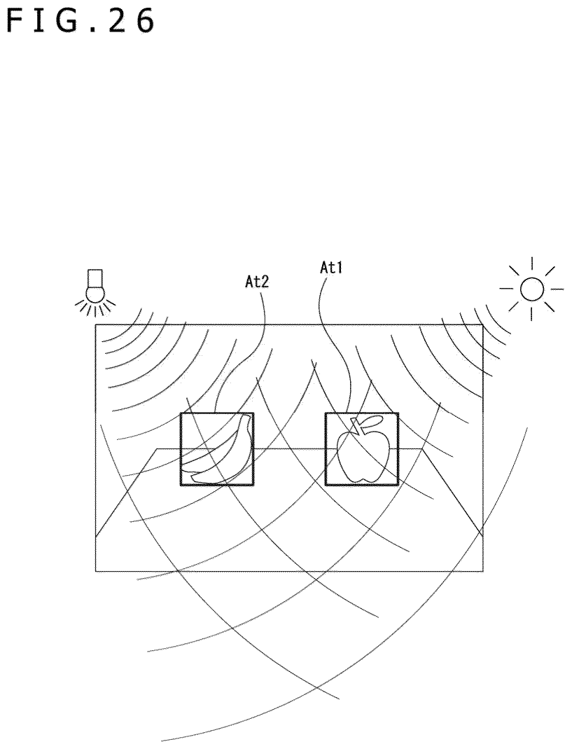

FIG. 25 is a block diagram for explaining a configuration example of a signal processing device 11I as a seventh example in the first embodiment.

In the seventh example, the polarization image generating section 13 generates and outputs a polarization component image and a reflection-removed image as multiple polarization images as depicted in the figure. The polarization component image output by the polarization image generating section 13 is input to an RGB detecting section 18, and the reflection-removed image is input to a signal processing section 14I and an object sensing section 80.

The object sensing section 80 performs an object sensing process on the reflection-removed image. Specifically, the object sensing section 80 performs a process of sensing a particular object designated as a target subject. For example, it is possible that, as the object sensing process here, a process using an artificial intelligence model generated by machine learning is performed. Alternatively, it is possible also that a rule-based process such as template matching is performed.

In a case where the object sensing section 80 senses a target subject as the particular object, the object sensing section 80 outputs information representing the position (e.g., the center position) of the target subject (hereinafter, written as “target subject positional information”), and information representing an area where an image of the target subject is captured, that is, information regarding the target subject area At.

The RGB detecting section 18 performs detection on the target subject area At identified by the object sensing section 80 on a polarization component image of each color of R, G, and B input from the polarization image generating section 13.

Detected values of each color of the polarization component images obtained by the RGB detecting section 18 are input to a control section 15I.

The signal processing section 14I performs a digital gain adjustment process of each color of the reflection-removed images (R, G, B) input from the polarization image generating section 13. In the present example, the signal processing section 14I performs such a digital gain adjustment process of each color of the reflection-removed images only on the target subject area At identified by the object sensing section 80.

The control section 15I controls signal processing parameters of the digital gain adjustment process of each color by the signal processing section 14I on the basis of the detected values obtained by the RGB detecting section 18, that is, the detected values of R, G, and B obtained by the sensing on the target subject area At in the polarization component images. Specifically, the control section 15I controls signal processing parameters of each color at the signal processing section 14I such that light source colors identified on the basis of the detected values of each color obtained by the RGB detecting section 18 are canceled.

Thereby, as a reflection-removed image (an image of the target subject area At) obtained after the RGB gain adjustment by the signal processing section 14I, an image on which the light source colors have been canceled can be obtained, and it becomes possible to identify the true color of the target subject.

Note that, in a case where it is assumed that there is a scene with a single light source, areas where identification of a light source color is performed are not limited to the target subject area At, ands can be any areas in an image frame.

Whereas it is assumed here that there is one target subject in the description above, it is possible also that multiple target subjects are sensed in an image frame as illustrated by FIG. 26, and identification of the color of each of the objects is performed. In such a case, it is sufficient if identification of light source colors, and cancellation of the light source colors are performed for each target subject.

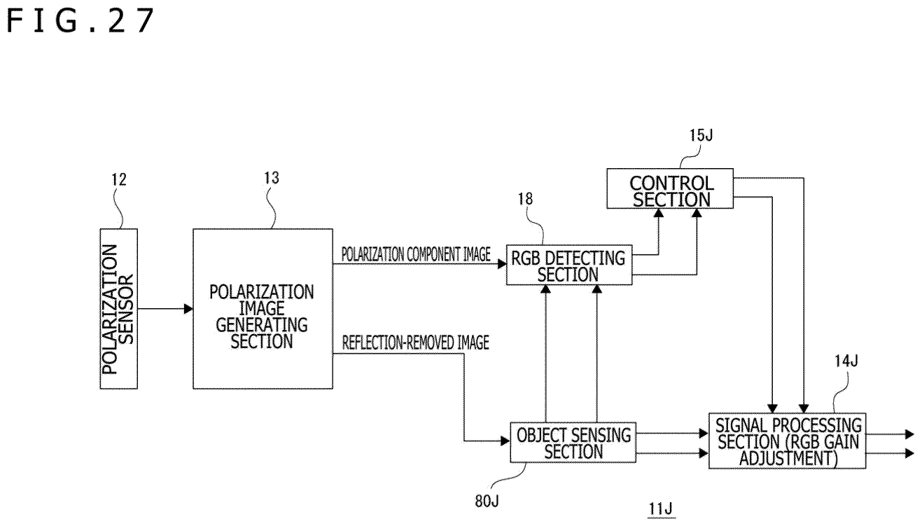

FIG. 27 is a block diagram for explaining a configuration example of a signal processing device 11J having a function to cancel light source colors of each target subject like the one described above.

In the signal processing device 11J, an object sensing section 80J has an object sensing function similar to that of the object sensing section 80, but is different from the object sensing section 80 in that, in a case where a target subject is sensed, the object sensing section 80J outputs, to a signal processing section 14J, only an image of the target subject area At on a reflection-removed image.

The signal processing section 14J performs a digital gain adjustment process of each color of the image of the target subject area output by the object sensing section 80J in this manner.

In a case where multiple target subjects are sensed by the object sensing section 80J, the RGB detecting section 18 in this case performs detection of each color of a polarization component image for each target subject area At of the target subjects.

In a case where multiple target subjects are sensed, a control section 15J controls signal processing parameters of the digital gain adjustment process of each target subject area At by the signal processing section 14J such that a light source color of the target subject area At is canceled on the basis of detected values of the target subject area At obtained by the RGB detecting section 18.

Thereby, it becomes possible to identify the true color of each sensed target subject.

Here, since light source colors can be identified using a polarization component image (specular reflection component) in a case where the polarization sensor 12 is used, it is possible to remove necessity, in identification of light source colors, for performing calibration based on a gray chart that is used in a case where an RGB sensor is used. Specifically, whereas, in an approach that is adopted in a case where the polarization sensor 12 is not used, but an RGB sensor is used, a gray chart is captured, RGB values of gray areas are acquired as light source colors in advance, and WB adjustment to cancel the light source colors is performed on the basis of the RGB values at the time of actual image capturing, in a case where the polarization sensor 12, it becomes unnecessary to perform such calibration using a gray chart since identification of light source colors using a polarization component image can be performed.

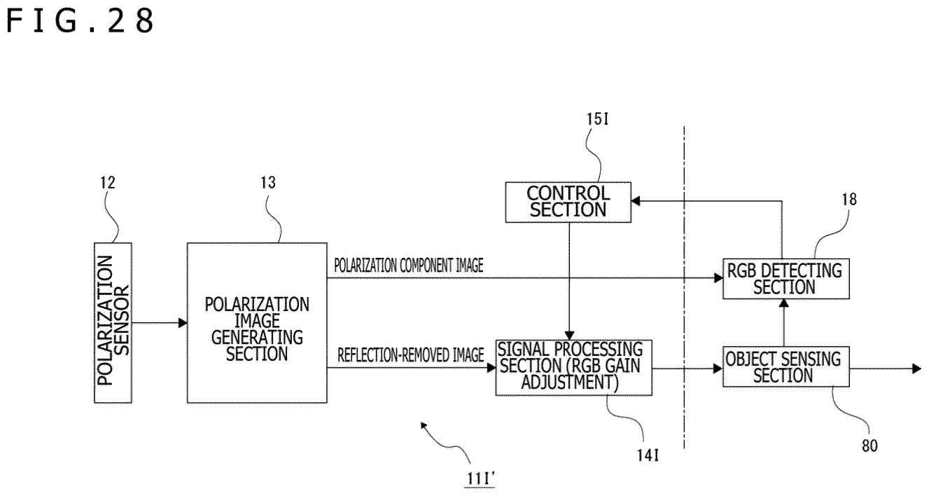

Here, as depicted as a signal processing device 11I′ in FIG. 28, it is possible that a signal processing device is configured by forming, in a single semiconductor package, the polarization image generating section 13, the signal processing section 14I, and the control section 15I along with the polarization sensor 12. In this case, the object sensing section 80 and the RGB detecting section 18 can also be provided outside the signal processing device 11I′.

In such configuration, the object sensing section 80 performs an object sensing process on a reflection-removed image input through the signal processing section 14I.

### 2. Second Embodiment

### 2-1. First Example

In a second embodiment, a spectral sensor is included as the light reception sensor 2. The spectral sensor means a light reception sensor for obtaining multiple narrow-band images to serve as wavelength characteristics analysis images about light from subjects.

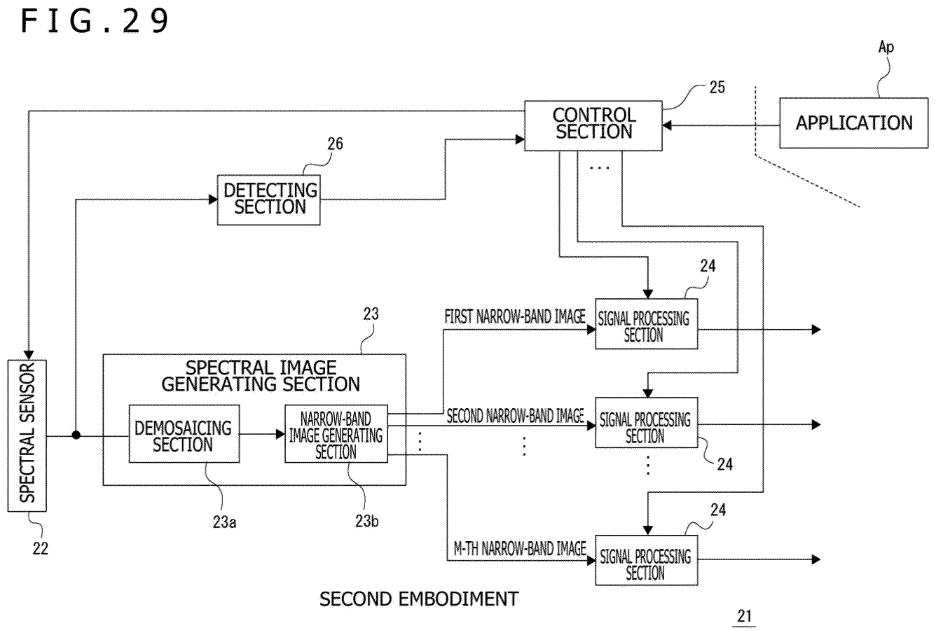

FIG. 29 is a block diagram for explaining a configuration example of a signal processing device 21 as a first example in the second embodiment.

The signal processing device 21 includes a spectral sensor 22, a spectral image generating section 23, signal processing sections 24, a control section 25, and a detecting section 26. Note that the application Ap here conceptually represents a computer device that executes an application program for receiving and processing an input of at least one of multiple narrow-band images generated at the signal processing device 21.

The application Ap may be configured integrally with the signal processing device 21, or may be configured separately from the signal processing device 21.

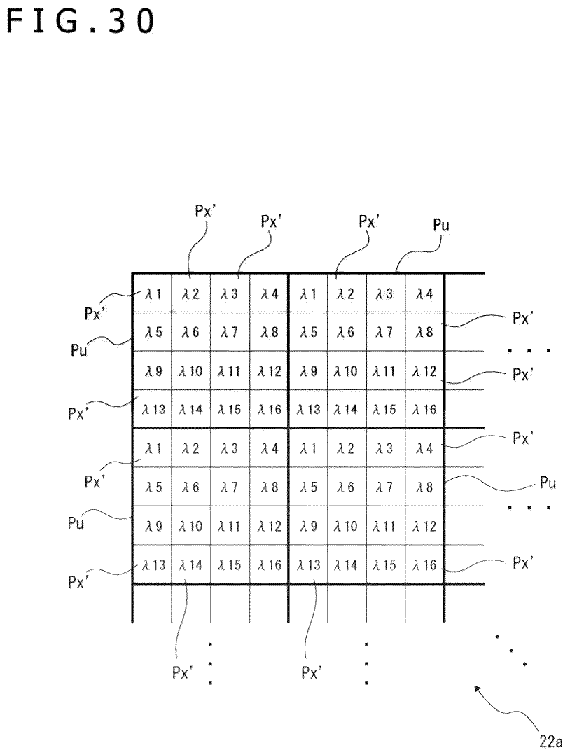

FIG. 30 is a figure schematically depicting a configuration example of a pixel array section 22a of the spectral sensor 22.

As depicted in the figure, spectral pixel units Pu each having multiple pixels Px′ that receive light in mutually different wavelength bands, and are two-dimensionally arrayed in a predetermined pattern are formed in the pixel array section 22a. The pixel array section 22a has the two-dimensionally arrayed spectral pixel units Pu.

Whereas the example depicted in the figure is an example in which each spectral pixel unit Pu receives, separately at each pixel Px′, light in any of 16 wavelength bands from λ1 to λ16 in total, and, stated differently, is an example in which the number of wavelength bands that are separately received in each spectral pixel unit Pu (hereinafter, written as the number of light reception channels) is 16, this is merely depicted as an example for explanation, and the number of light reception channels in each spectral pixel unit Pu can be set to any number.

Here, it is assumed hereinbelow that the number of light reception channels in each spectral pixel unit Pu is “N.”

In FIG. 29, the spectral image generating section 23 generates M narrow-band images on the basis of a RAW image as an image output from the spectral sensor 22. Here, M>N.

Specifically, the spectral image generating section 23 has a demosaicing section 23a and a narrow-band image generating section 23b. The demosaicing section 23a performs a demosaicing process on the RAW image from the spectral sensor 22, and the narrow-band image generating section 23b performs a linear matrix process based on a wavelength band image of each of the N channels obtained by the demosaicing process to thereby generate M narrow-band images from the N wavelength band images.

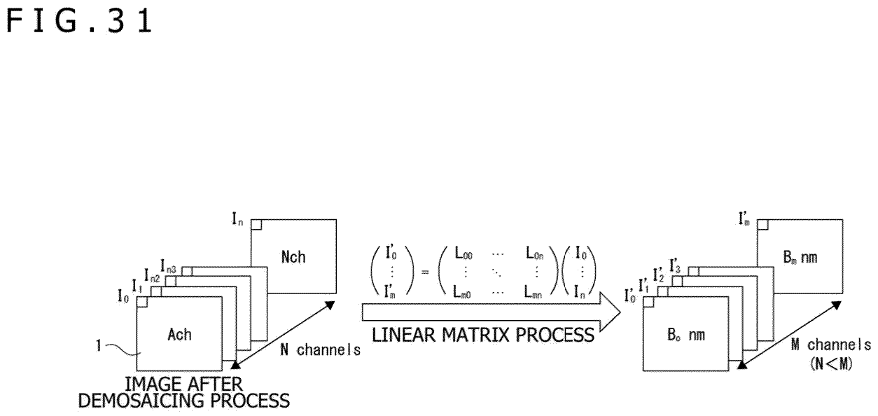

FIG. 31 is a figure for explaining the linear matrix process for obtaining M narrow-band images.

By performing a matrix computation like the one depicted in the figure for each pixel position on the basis of a wavelength band image of each of the N channels obtained by the demosaicing process by the demosaicing section 23a, a narrow-band image of each of the M channels is obtained.

In FIG. 29, the signal processing sections 24 perform a signal processing on narrow-band images generated by the spectral image generating section 23. In the present example, each signal processing section 24 is provided for one of the M narrow-band images. Each signal processing section 24 performs a digital gain adjustment process on a narrow-band image as signal processing.

The detecting section 26 performs detection on the RAW image output from the spectral sensor 22, and outputs detected values to the control section 25.

For example, the control section 25 includes a microcomputer having a CPU, a ROM, a RAM, and the like, and controls an operation by the signal processing device 21.

Specifically, the control section 25 in the present example performs exposure adjustment of the spectral sensor 22 on the basis of the detected values of the RAW image obtained by the detecting section 26. That is, the exposure adjustment is exposure adjustment as AE for preventing flared highlights or blocked up shadows of the RAW image.

In addition, the control section 25 controls signal processing parameters of the digital gain adjustment process in each signal processing section 24 on the basis of an instruction from the application Ap.

Here, differences in brightness can be generated between narrow-band images even if images of the same subject are captured in the narrow-band images. In view of this, in the present example, the application Ap gives an instruction to the control section 25 about signal processing parameters (signal processing parameters of the digital gain adjustment process) for negating the differences in brightness between the narrow-band images, and the control section 25 sets the thus-instructed signal processing parameters for the respective corresponding signal processing sections 24.

Thereby, it becomes possible to perform signal processing on narrow-band images such that the brightness of each narrow-band image becomes appropriate in a case where multiple narrow-band images include at least one narrow-band image with brightness which is different from the brightness of other narrow-band images.

Accordingly, it is possible to attempt to acquire appropriate narrow-band images.

Note that whereas the exposure adjustment of the spectral sensor 22 based on the detected values of the RAW image is performed in the present example, in this case, the brightness of the narrow-band images does not become appropriate in some cases even if the brightness of the RAW image is adjusted appropriately. In such a case, it is possible also to control signal processing parameters of each signal processing section 24 dynamically on the basis of the detected values of the RAW image by using a table similar to the table TbB explained with reference to the third example in the first embodiment.

Alternatively, as control similar to that in the fourth example in the first embodiment, it is possible also to perform detection for each narrow-band image, and control signal processing parameters of each narrow-band image dynamically on the basis of detected values obtained by the detection.

In this case also, the detected values can also be inferred from detected values of other images by using an artificial intelligence model.

In addition, whereas it is assumed in the description above that an optical bandpass filter is provided for each pixel Px′, and light in each wavelength band is received separately in the spectral sensor 22, the spectral sensor 22 can also be configured as a sensor having a structure using the principle of diffraction to acquire spectral images, a sensor that has a thin film using a photonic crystal, and placed on an image sensor, and acquires spectral images, a sensor that uses the principle of plasmon resonance to obtain spectral images, or the like.

### 2-2. Second Example

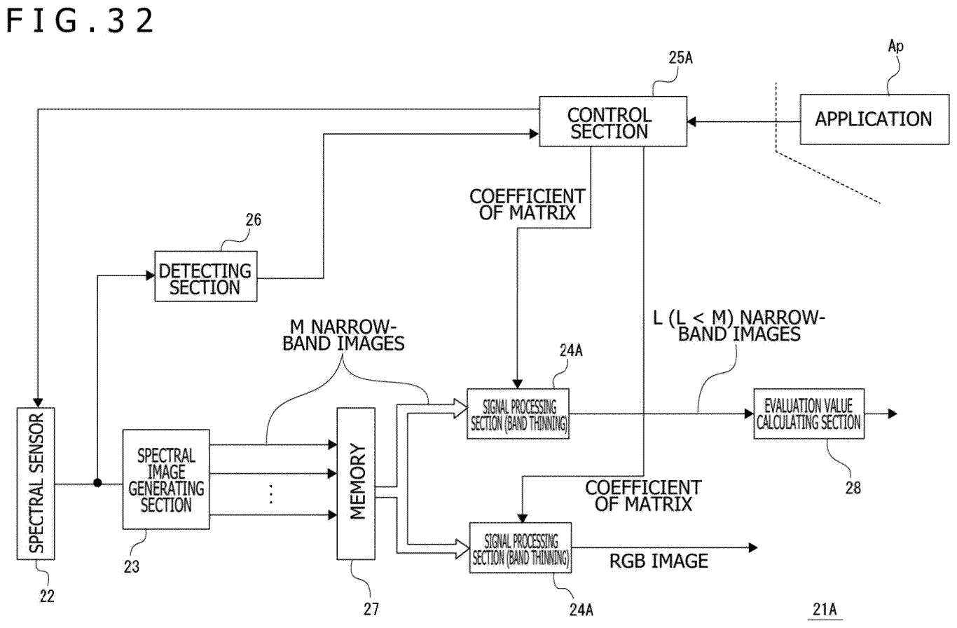

FIG. 32 is a block diagram for explaining a configuration example of a signal processing device 21A as a second example in the second embodiment.

The second example is an example in which signal processing on narrow-band images is a band thinning process.

The signal processing device 21A is different from the signal processing device 21 in the first example in that the signal processing device 21A additionally has a memory 27, is provided with signal processing sections 24A instead of the signal processing sections 24, is provided with a control section 25A instead of the control section 25, and additionally has an evaluation value calculating section 28.

The memory 27 temporarily retains M narrow-band images generated by the spectral image generating section 23.

The signal processing sections 24A perform the band thinning process on the M narrow-band images by performing a matrix computation on the M narrow-band images. The band thinning process mentioned here means a process of generating, from the M narrow-band images, images of wavelength bands fewer than the M narrow-band images.

In the present example, two signal processing sections 24A are provided, and each signal processing section 24A receives inputs of the M narrow-band images retained in the memory 27, and performs the band thinning process on the M narrow-band images.

Thereby, it is made possible to generate band-thinned images of multiple systems from the M narrow-band images. At this time, it is possible to cause each signal processing section 24A to generate images by a different manner of band thinning by setting coefficients of a matrix used by the signal processing section 24A for the matrix computation.

Whereas the control section 25A has a function to perform exposure adjustment of the spectral sensor 22 on the basis of detected values obtained by the detecting section 26 similarly to the control section 25, the control section 25A is different from the control section 25 in that the control section 25A has a function to control signal processing parameters of the signal processing sections 24A, specifically a function to control coefficients of matrices used by the signal processing sections 24A for the matrix computation.

Here, for example, examples of use of spectral images acquired by using the spectral sensor 22 include use in vegetation analysis of plants such as vegetables or fruit trees. For example, as an evaluation index for vegetation analysis, the NDVI (normalized vegetation index) based on light-reception values of the red wavelength band (Red) and light-reception values of the near infrared wavelength band (NIR) is known. Specifically, NDVI=(NIR−Red)/(NIR+Red).

Typically, evaluation indices about vegetation are calculated on the basis of L narrow-band images which are fewer than the M narrow-band images.

In addition, narrow-band images are images which are visually unnatural for humans, and images not suited for visually recognizing the shapes or colors of subjects. Because of this, it is required to generate, from M narrow-band images, images on which subjects can be visually recognized by humans, for example, RGB images or the like.

In view of this, in the present example, one signal processing section 24A is caused to generate L narrow-band images for vegetation analysis, specifically two narrow-band images for calculating the NDVI described above, and the other signal processing section 24A is caused to generate an image on which subjects can be visually recognized by humans, specifically an RGB image.

In the present example, the application Ap inputs, to the control section 25A, coefficients of a matrix for generating the L narrow-band images, and coefficients of a matrix for generating the RGB image, and the control section 25A sets the coefficients of the former matrix for the one signal processing section 24A, and sets the coefficients of the latter matrix for the other signal processing section 24A.

Here, the matrix computation for obtaining the L narrow-band images from the M narrow-band images is represented by [Formula 1] described below.

$$[ Math . 1 ]$$

$${I}^{′} = ( \begin{matrix}0 & … & 0 \\ 0 & ⋱ & 0 \\ 0 & … & 1\end{matrix} ) ( \begin{matrix}{I}_{1} \\ ⋮ \\ {I}_{M}\end{matrix} ) \qquad [ Formula 1 ]$$

Note that only the values of coefficients of necessary bands in the matrix are set to “1” in [Formula 1].

In addition, the matrix computation for obtaining the RGB image from the M narrow-band images is represented by [Formula 2] described below.

$$[ Math . 2 ]$$

$$( \begin{matrix}{I}_{R}^{′} \\ {I}_{G}^{′} \\ {I}_{B}^{′}\end{matrix} ) = ( \begin{matrix}{C}_{1 R} & … & {C}_{MR} \\ {C}_{1 G} & … & {C}_{MB} \\ {C}_{1 B} & … & {C}_{MB}\end{matrix} ) ( \begin{matrix}{I}_{1} \\ ⋮ \\ {I}_{M}\end{matrix} ) \qquad [ Formula 2 ]$$

By causing the control section 25A to set coefficients of the matrices in a manner like the one described above, it is possible to generate band-thinned images of two systems, which are the L narrow-band images and the RGB image, from the M narrow-band images.

The evaluation value calculating section 28 obtains a vegetation evaluation image (vegetation evaluate map) by calculating an evaluation value as the NDVI for each pixel position on the basis of the L narrow-band images (two images of the red wavelength band and the near infrared wavelength band in the present example) generated by the one signal processing section 24A described above.

According to the signal processing device 21A as the second example like the one described above, by setting coefficients of the matrices for the signal processing sections 24A, it is possible to generate appropriate band-thinned images as requested by a user or the application Ap.

Here, the evaluation value calculating section 28 may calculate vegetation evaluation values for all the pixels, or it is possible also that the evaluation value calculating section 28 calculates vegetation evaluation values of only an image area where an image of a target plant is captured (plant image area) in a case where the plant image area is known.

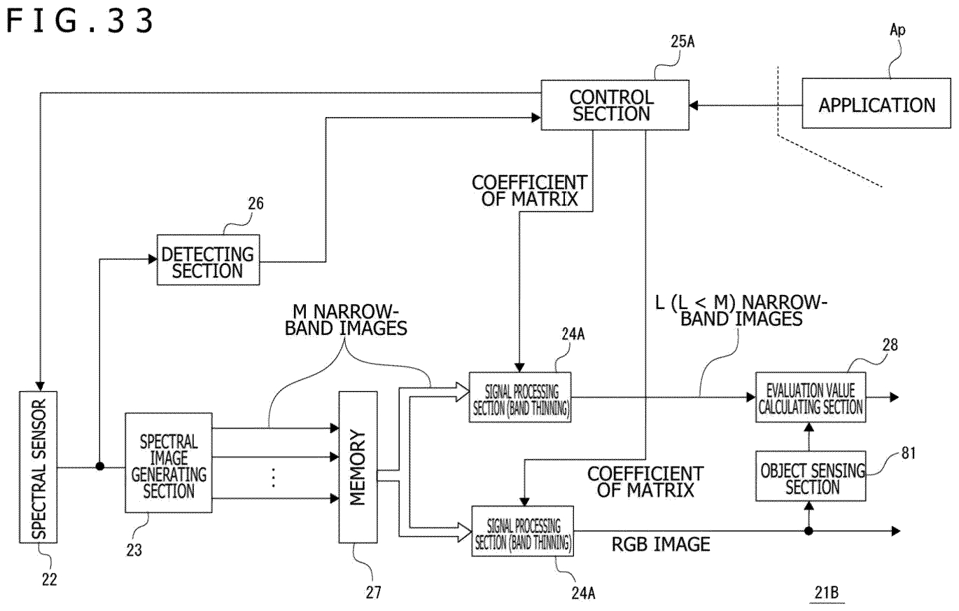

For example, like a signal processing device 21B depicted in FIG. 33, it is possible to adopt configuration in which an object sensing section 81 that performs an object sensing process based on an RGB image, specifically an object sensing process of sensing a target plant, is provided, and information regarding a plant image area identified on the basis of the object sensing process is input to the evaluation value calculating section 28.

At this time, it is possible also that the evaluation value calculating section 28 calculates the average value (scalar value) of vegetation evaluation values of the plant image area.

### 2-3. Third Example

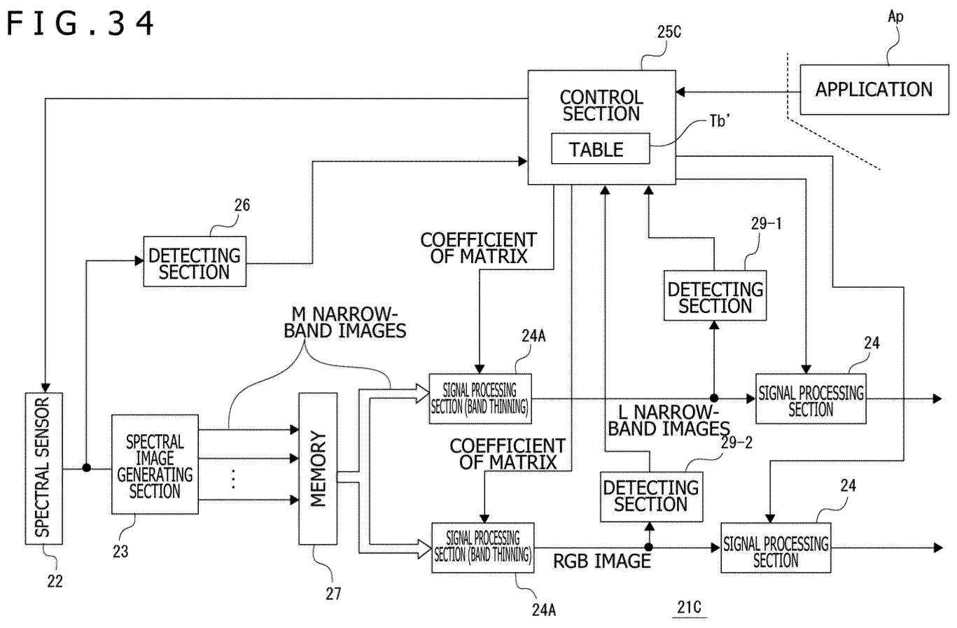

FIG. 34 is a block diagram for explaining a configuration example of a signal processing device 21C as a third example in the second embodiment.

In the third example, a brightness adjustment function for each of L narrow-band images and an RGB image is added to the configuration in the second example.

The signal processing device 21C is different from the signal processing device 21A in the second example in that the signal processing device 21C additionally has two signal processing sections 24, additionally has a detecting section 29-1 and a detecting section 29-2, and is provided with a control section 25C instead of the control section 25A.

As depicted in the figure, one signal processing section 24 receives inputs of the L narrow-band images output by one signal processing section 24A of the two signal processing sections 24A, and performs a digital gain adjustment process on the L narrow-band images.

The other signal processing section 24 receives an input of the RGB image output by the other signal processing section 24A, and performs a digital gain adjustment process on the RGB image.

The detecting section 29-1 performs detection on the L narrow-band images output by the one signal processing section 24A, and outputs detected values to the control section 25C. The detecting section 29-2 performs detection on the RGB image output by the other signal processing section 24A, and outputs detected values to the control section 25C.

The control section 25C dynamically controls signal processing parameters of each signal processing section 24 on the basis of the detected values from each of the detecting sections 29-1 and 29-2, that is, the detected values of the L narrow-band images and the detected values of the RGB image, and a table Tb′.

In this case, the table Tb′ has stored thereon, for each of the L narrow-band images and the RGB image, correspondence information representing the correspondence between the levels of detected values and signal processing parameters that should be set.

The control section 25C performs a process of identifying signal processing parameters that should be set for each of the L narrow-band images and the RGB image on the basis of the detected values of each of the L narrow-band images and the RGB image, and the table Tb′, and setting the identified signal processing parameters for the respective corresponding signal processing sections 24.

Thereby, gain control can be performed such that the brightness of each of the L narrow-band images and the RGB image becomes desired brightness.

At this time, regarding the brightness (gains) of the L narrow-band images, the same gain is given such that the ratio among the bands is not lost.

Here, in this case also, detected values may be inferred from detected values of other images by using an artificial intelligence model.

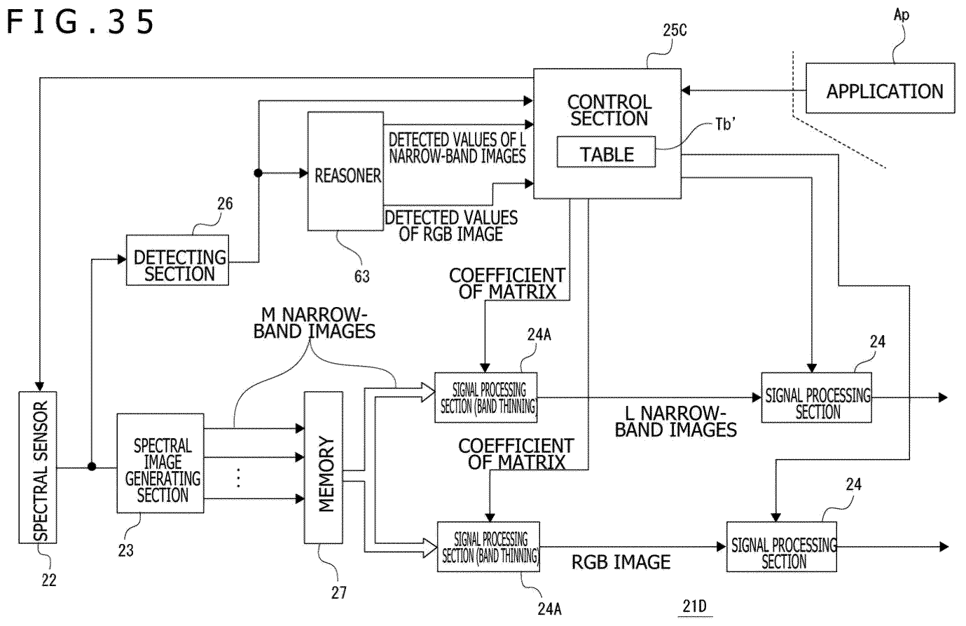

FIG. 35 is a block diagram for explaining a configuration example of a signal processing device 21D that infers detected values of L narrow-band images and an RGB image from a RAW image.

As depicted in the figure, the signal processing device 21D is provided with a reasoner 63 that infers detected values of the L narrow-band images and the RGB image by using an artificial intelligence model and receiving inputs of detected values of the RAW image obtained by the detecting section 26. The artificial intelligence model used at the reasoner 63 can be obtained by machine learning using detected values of RAW images obtained by the spectral sensor 22 as training input data, and using detected values of L narrow-band images and detected values of RGB images as correct answer data.

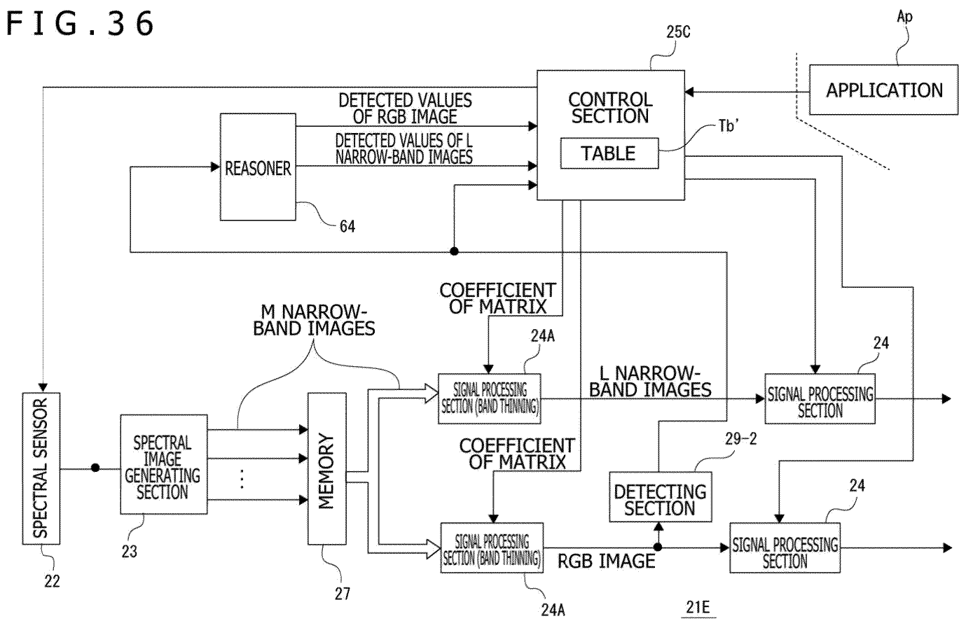

FIG. 36 is a block diagram for explaining a configuration example of a signal processing device 21E that infers detected values of a RAW image and L narrow-band images from an RGB image.

The signal processing device 21E is provided with a reasoner 64 that infers detected values of a RAW image obtained by the spectral sensor 22 and detected values of L narrow-band images by using an artificial intelligence model and receiving inputs of detected values of an RGB image obtained by the detecting section 29-2. The artificial intelligence model used at the reasoner 64 can be obtained by machine learning using detected values of RGB images as training input data, and using detected values of RAW images obtained by the spectral sensor 22 and detected values of L narrow-band images as correct answer data.

Here, in the second embodiment also, it is possible also that relearning of the artificial intelligence model of the reasoner is performed by a procedure similar to that in the case of the sixth example in the first embodiment. For example, the relearning is performed when a predetermined condition related to a length of elapsed time, the operation situation of AE, or the like is satisfied, and so on.

In addition, in a case where the relearning is performed, it is possible also to perform control to update the artificial intelligence model based on results of evaluation regarding inference results of the relearning model like the one explained in relation to the validating section F2 or the model update control section F3 mentioned before.

### 2-4. Fourth Example

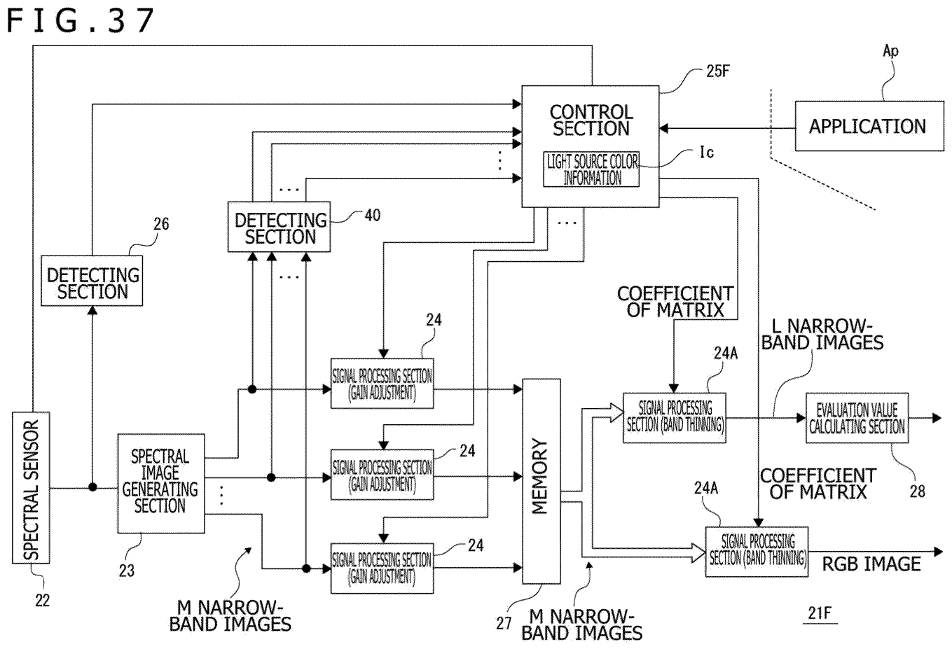

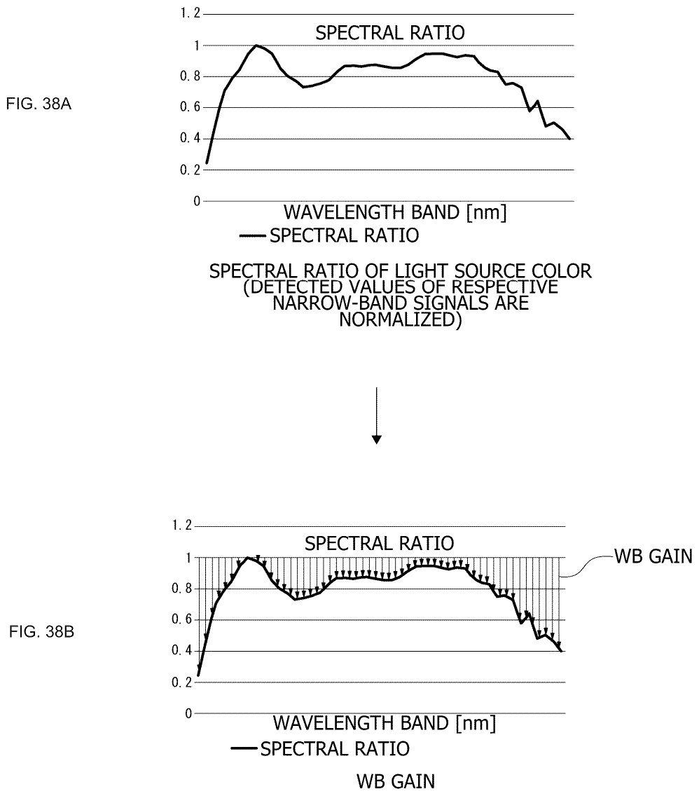

FIG. 37 is a block diagram for explaining a configuration example of a signal processing device 21F as a fourth example in the second embodiment.

In the fourth example, a process of light source color cancellation on M narrow-band images is performed.

The signal processing device 21F is different from the signal processing device 21A (FIG. 32) as the second example in that the signal processing device 21F additionally has a detecting section 40 and signal processing sections 24, and is provided with a control section 25F instead of the control section 25A.

The detecting section 40 performs detection on M narrow-band images output from the spectral image generating section 23.

The signal processing sections 24 are each inserted on an input line of the M narrow-band images from the spectral image generating section 23 to the memory 27. That is, each signal processing section 24 performs signal processing (digital gain adjustment process) on mutually different narrow-band images of the M narrow-band images output from the spectral image generating section 23, and outputs the narrow-band images to the memory 27.

The control section 25F cancels light source colors from the M narrow-band images by controlling signal processing parameters of the digital gain adjustment process at each signal processing section 24 on the basis of detected values of each of the M narrow-band images detected by the detecting section 40.

In the digital gain adjustment (WB adjustment) for such light source color cancellation, the control section 25F uses light source color information Ic. The light source color information Ic is one that is obtained by obtaining light source colors as information regarding luminance distribution of M bands by preliminary calibration using a gray chart.

Specifically, the control section 25F acquires in advance, as the light source color information Ic, information regarding detected values obtained by detection performed by the detecting section 40 for the M narrow-band images obtained by causing the spectral sensor 22 to execute a light receiving operation using the gray chart as a subject.

FIG. 38 is a figure for explaining an example of calculation of a gain (WB gain) for light source color cancellation. FIG. 38A depicts an example of a spectral ratio obtained by capturing a gray chart (detected values of each of the M bands are normalized as a gain), and FIG. 38B depicts an example of a WB gain for light source color cancellation calculated for the spectral ratio in FIG. 38A (a gain that should be set for each of the M bands). As depicted in FIG. 38B, a gain of the difference between the flat spectral ratio equivalent to gray and the spectral ratio in FIG. 38A can be determined as the WB gain for the light source color cancellation.

The control section 25F controls signal processing parameters of each signal processing section 24 such that the gain of each of the M bands for the light source color cancellation determined as the difference like the one described above is applied to the M narrow-band images. Thereby, it becomes possible to remove color casts of light source colors from the M narrow-band images.

Note that whereas acquisition of detected values of the M narrow-band images needs to be made possible in performing the light source color cancellation of the M narrow-band images as described above, in this case, detected values of at least one of the M narrow-band images can also be inferred using an artificial intelligence model from other images such as a RAW image or other narrow-band images.

### 3. Third Embodiment

In a third embodiment, the iToF sensor 32 is used as the light reception sensor 2. The iToF sensor means a light reception sensor configured to be capable of executing a light receiving operation for distance measurement by an iToF scheme for each pixel.

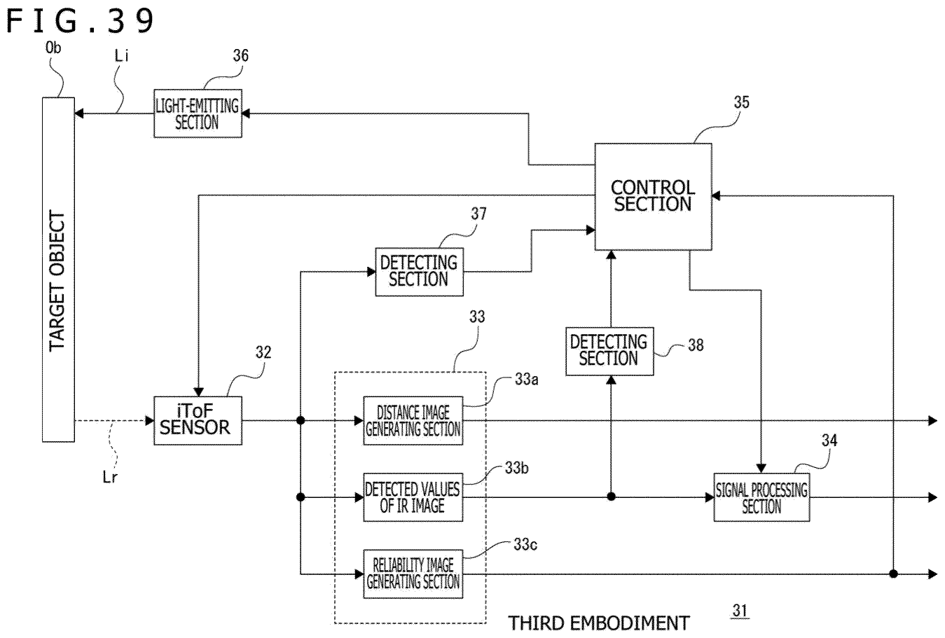

FIG. 39 is a block diagram for explaining a configuration example of a signal processing device 31 as a third embodiment.

As depicted in the figure, the signal processing device 31 includes a light-emitting section 36 that emits light, and the iToF sensor 32 configured to be capable of a light receiving operation for distance measurement by the iToF scheme using reflection light Lr (depicted as the reflection light Lr from a target object Ob in the figure) obtained by reflection of the light (depicted as emission light Li in the figure) emitted by the light-emitting section 36 on an object. Also, the signal processing device 31 includes an image generating section 33, a signal processing section 34, a detecting section 37, and a detecting section 38.

Here, it is assumed that the iToF scheme is a distance measurement scheme in which the distance to the target object Ob is calculated on the basis of the phase difference between the emission light Li emitted to the target object Ob and the reflection light Lr obtained by reflection of the emission light Li on the target object Ob.

The light-emitting section 36 has one or more light-emitting elements as a light source, and emits the emission light Li. For example, it is possible that, as the light source of the light-emitting section 36, a light-emitting element such as a VCSEL (vertical cavity surface emitting laser) is used.

For example, as the emission light Li, the light-emitting section 36 emits IR (infrared) light with a wavelength in the range of 750 to 1400 nm.

The iToF sensor 32 receives the reflection light Lr. Specifically, a light receiving operation to receive the reflection light Lr is performed such that it becomes possible to sense the phase difference between the reflection light Lr and the emission light Li.

As mentioned later also, the iToF sensor 32 has a photoelectric converting element (photodiode PD) and a pixel array section 111 having multiple two-dimensionally-arrayed pixels Px″ each including a first transfer gate element (transfer transistor TG-A) for transferring an accumulated electric charge of the photoelectric converting element and a second transfer gate element (transfer transistor TG-B). The iToF sensor 32 performs a light receiving operation for distance measurement by the iToF scheme for each pixel Px “.

Although not depicted in the figure, an optical bandpass filter (IR filter) for selectively receiving IR light is formed in each pixel”.

For example, a control section 35 is configured by using a microcomputer having a CPU, a ROM, a RAM, and the like, and controls a light-emitting operation by the light-emitting section 36 to emit the emission light Li, an operation by the iToF sensor 32, and an operation by the signal processing section 24.

Here, in a case where distance measurement by the iToF scheme is performed, light that is intensity-modulated such that the intensity changes at predetermined intervals is used as the emission light Li. Specifically, in the present example, pulsed light is emitted repeatedly at predetermined intervals as the emission light Li. Hereinbelow, such intervals at which the pulsed light is emitted are written as “light emission intervals Cl.” In addition, a period between light-emission start timings of the pulsed light when the pulsed light is emitted repeatedly at the light emission intervals Cl is written as “one modulation period Pm” or simply a “modulation period Pm.”

The control section 35 controls the light-emitting operation by the light-emitting section 36 such that the emission light Li is emitted only for a predetermined light-emitted period in each modulation period Pm.

In the iToF scheme, for example, the length of the light emission intervals Cl is set relatively short to approximately several tens of MHz to several hundreds of MHz.

Here, as known, in the iToF scheme, a signal electric charge accumulated in the photoelectric converting element in a pixel Px″ of the iToF sensor 32 is allocated to two floating diffusions (FD) by the first transfer gate element and the second transfer gate element that are turned on alternately. At this time, intervals at which the first transfer gate element and the second transfer gate element are alternately turned on are the same intervals as the light emission intervals Cl of the light-emitting section 36. That is, each of the first transfer gate element and the second transfer gate element is turned on once after each modulation period Pm, and the allocation of a signal electric charge to two floating diffusions like the one described above is performed repeatedly after each modulation period Pm.

For example, the transfer transistor TG-A as the first transfer gate element is turned on for a light-emitted period of the emission light Li in a modulation period Pm, and the transfer transistor TG-B as the second transfer gate element is turned on for a light-unemitted period of the emission light Li in the modulation period Pm.

Since the length of the light emission intervals Cl is set relatively short as mentioned before, the amount of a signal electric charge accumulated in each floating diffusion due to the allocation performed once using the first and second transfer gate elements like the one described above becomes relatively very small. Because of this, in the indirect ToF scheme, light-emission of the emission light Li is repeated approximately thousands of times to tens of thousands of times per distance measurement, and the iToF sensor 32 repeatedly performs the allocation of a signal electric charge to each floating diffusion using the first and second transfer gate elements like the one described above while the emission light Li is emitted repeatedly in this manner.

As can be understood from the explanation described above, the iToF sensor 32 drives the first transfer gate element and second transfer gate element of each pixel Px″ at timings based on the light emission intervals of the emission light Li. Because of this, the control section 35 controls a light receiving operation by the iToF sensor 32, and a light-emitting operation by the light-emitting section 36 on the basis of a common clock.

Here, the configuration of the iToF sensor 32 is explained.

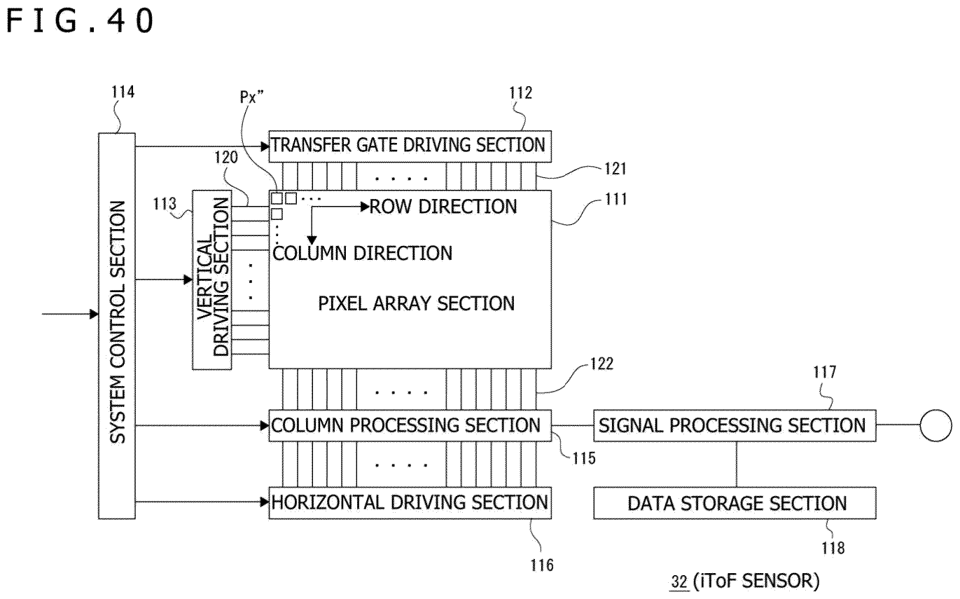

FIG. 40 is a block diagram depicting an internal circuit configuration example of the iToF sensor 32.

As depicted in the figure, the iToF sensor 32 includes the pixel array section 111, a transfer gate driving section 112, a vertical driving section 113, a system control section 114, a column processing section 115, a horizontal driving section 116, a signal processing section 117, and a data storage section 118.

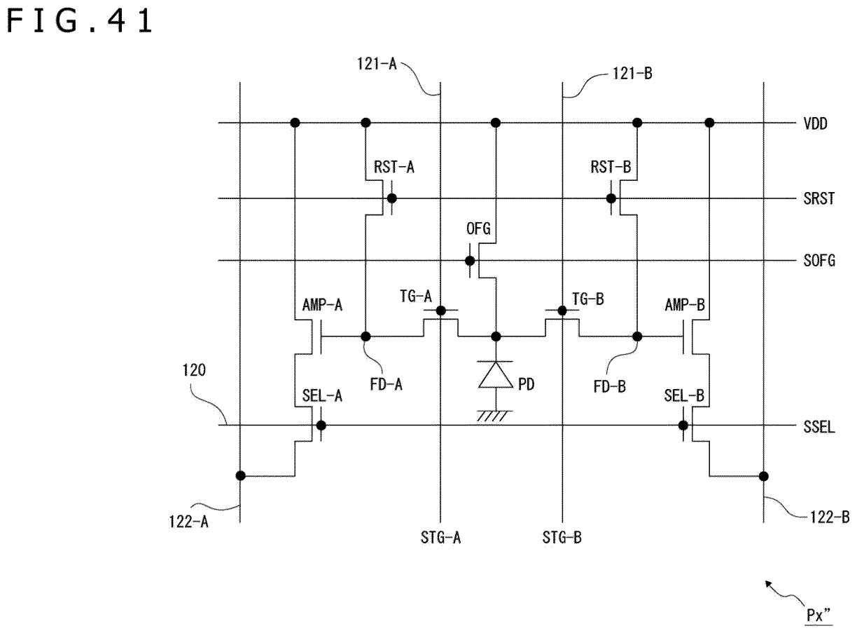

The pixel array section 111 has configuration in which multiple pixels Px″ are arrayed two-dimensionally in a matrix having a row direction and a column direction. Each pixel Px″ has a photodiode PD mentioned later as a photoelectric converting element. Note that details of the pixels Px″ are explained later on with reference to FIG. 41.

Here, the row direction is the horizontal array direction, and the column direction is the vertical array direction. In the figure, the row direction is the width direction, and the column direction is the depth direction.

In the matrix-like pixel array in the pixel array section 111, a row drive wire 120 is placed along the row direction for each pixel row, and two gate drive lines 121 and two vertical signal wires 122 are placed along the column direction for each pixel column. For example, the row drive wires 120 transfer drive signals for performing driving when signals are read out from the pixels Px “. Note that whereas FIG. 40 depicts one wire as each row drive wire 120, each row drive wire 120 is not necessarily one line. One end of each row drive wire 120 is connected to an output terminal of the vertical driving section 113 corresponding to the row.

The system control section 114 is configured by using a timing generator that generates various types of timing signal or the like, and drive control of the transfer gate driving section 112, the vertical driving section 113, the column processing section 115, the horizontal driving section 116, and the like is performed on the basis of the various types of timing signal generated by the timing generator.

On the basis of control by the system control section 114, the transfer gate driving section 112 drives two transfer gate elements provided to each pixel Px” through two gate drive lines 121 provided to each pixel column as described above.

As mentioned before, it is assumed that the two transfer gate elements are turned on alternately after each modulation period Pm. Because of this, the system control section 114 supplies the transfer gate driving section 112 with a clock signal input from the control section 35 mentioned before, and, on the basis of the clock signal, the transfer gate driving section 112 drives the two transfer gate elements.

The vertical driving section 113 is configured by using a shift register, an address decoder, or the like, and drives the pixels Px″ of the pixel array section 111 all the pixels at a time, in units of rows, and so on. That is, along with the system control section 114 that controls the vertical driving section 113, the vertical driving section 113 is included in a driving section that controls an operation by each pixel Px″ of the pixel array section 111.

A light-reception signal output (read out) from each pixel Px″ in a pixel row according to the drive control by the vertical driving section 113, specifically a signal representing the electric charge amount of a signal electric charge accumulated in each of the two floating diffusions provided to each pixel Px″, is input to the column processing section 115 through a corresponding vertical signal wire 122. The column processing section 115 performs predetermined signal processing on a light-reception signal read out from each pixel Px″ through a vertical signal wire 122, and temporarily retains the light-reception signal after the signal processing. Specifically, the column processing section 115 performs, as the signal processing, a noise removal process by CDS (correlated double sampling), an A/D (Analog to Digital) conversion process, or the like.

Here, readout of two light-reception signals (a sensing signal of each floating diffusion) from each pixel Px″ is performed once every time after a predetermined number of times of repeated emission of the emission light Li is performed (every time after thousands of times to tens of thousands of times of repeated emission mentioned before is performed).

Accordingly, the system control section 114 controls the vertical driving section 113 on the basis of the clock signal mentioned before, and performs control such that readout timings of light-reception signals from each pixel Px come every time after a predetermined number of times of repeated emission of the emission light Li is performed in this manner.

The horizontal driving section 116 is configured by using a shift register, an address decoder, or the like, and sequentially selects a unit circuit in the column processing section 115 corresponding to a pixel column. Due to this selection and scanning by the horizontal driving section 116, light-reception signals signal-processed by each unit circuit in the column processing section 115 are output sequentially.

The signal processing section 117 has at least a computation processing function, and implements predetermined signal processing on light-reception signals output from the column processing section 115.

The data storage section 118 temporarily stores data necessary for the signal processing at the signal processing section 117.

FIG. 41 depicts an equivalent circuit of the pixels Px″ two-dimensionally arrayed in the pixel array section 111.

Each pixel Px″ has one photodiode PD as a photoelectric converting element and one OF (overflow) gate transistor OFG. In addition, the pixel Px″ has two transfer transistors TG as transfer gate elements, two floating diffusions FD, two reset transistors RST, two amplification transistors AMP, and two selection transistors SEL.

Here, in a case where a distinction is made between a pair of the transfer transistors TG, the floating diffusions FD, the reset transistors RST, the amplification transistors AMP, and the selection transistors SEL provided to each pixel Px″, as depicted in FIG. 41, they are written as transfer transistors TG-A and TG-B, floating diffusions FD-A and FD-B, reset transistors RST-A and RST-B, amplification transistors AMP-A and AMP-B, and selection transistors SEL-A and SEL-B.

For example, the OF gate transistor OFG, the transfer transistors TG, the reset transistors RST, the amplification transistors AMP, and the selection transistors SEL are configured by using N-type MOS transistors.

The OF gate transistor OFG becomes conductive when an OF gate signal SOFG supplied to the gate is turned on. When the OF gate transistor OFG becomes conductive, the photodiode PD is clamped to a predetermined reference potential VDD, and the accumulated electric charge is reset.

Note that, for example, the OF gate signal SOFG is supplied from the vertical driving section 113.

The transfer transistor TG-A becomes conductive when a transfer drive signal STG-A supplied to the gate is turned on, and transfers a signal electric charge accumulated in the photodiode PD to the floating diffusion FD-A. The transfer transistor TG-B becomes conductive when a transfer drive signal STG-B supplied to the gate is turned on, and transfers an electric charge accumulated in the photodiode PD to the floating diffusion FD-B.

The transfer drive signals STG-A and STG-B are supplied from the transfer gate driving section 112 through gate drive lines 121-A and 121-B, each of which is provided as one of the gate drive lines 121 depicted in FIG. 40.

The floating diffusions FD-A and FD-B are electric charge retaining sections that temporarily retain electric charges transferred from the photodiode PD.

The reset transistor RST-A becomes conductive when a reset signal SRST supplied to the gate is turned on, and resets the potential of the floating diffusion FD-A to the reference potential VDD. Similarly, the reset transistor RST-B becomes conductive when the reset signal SRST supplied to the gate is turned on, and resets the potential of the floating diffusion FD-B to the reference potential VDD.

Note that, for example, the reset signal SRST is supplied from the vertical driving section 113.

The amplification transistor AMP-A has a source that is connected to a vertical signal wire 122-A via the selection transistor SEL-A, has a drain that is connected to the reference potential VDD (constant current source), and is included in a source follower circuit. The amplification transistor AMP-B has a source that is connected to a vertical signal wire 122-B via the selection transistor SEL-B, has a drain that is connected to the reference potential VDD (constant current source), and is included in a source follower circuit.

Here, each of the vertical signal wires 122-A and 122-B is provided as one of the vertical signal wires 122 depicted in FIG. 40.

The selection transistor SEL-A is connected between the source of the amplification transistor AMP-A and the vertical signal wire 122-A, becomes conductive when a selection signal SSEL supplied to the gate is turned on, and outputs an electric charge retained in the floating diffusion FD-A to the vertical signal wire 122-A via the amplification transistor AMP-A.

The selection transistor SEL-B is connected between the source of the amplification transistor AMP-B and the vertical signal wire 122-B, becomes conductive when the selection signal SSEL supplied to the gate is turned on, and outputs an electric charge retained in the floating diffusion FD-B to the vertical signal wire 122-B via the amplification transistor AMP-A.

Note that the selection signal SSEL is supplied from the vertical driving section 113 via the row drive wire 120.

An operation by the pixels Px″ is explained simply.

First, before starting light reception, a reset operation to reset the electric charges of all the pixels Px″ is performed. That is, for example, the OF gate transistor OFG, the reset transistors RST, and the transfer transistors IG are turned on (made conductive), and the accumulated electric charges of the photodiode PD and the floating diffusions FD are reset.

After the accumulated electric charges are reset, a light receiving operation for distance measurement is started at all the pixels. The light receiving operation mentioned here means a light receiving operation performed for one distance measurement. That is, during the light receiving operation, an operation to alternately turn on the transfer transistors TG-A and TG-B is repeated a predetermined number of times (approximately thousands of times to tens of thousands of times in the present example). Hereinbelow, the period of the light receiving operation performed for such one distance measurement is written as a “light reception period Pr.”

In one modulation period Pm of the light-emitting section 36 during the light reception period Pr, for example, after a period during which the transfer transistor TG-A is turned on (i.e., a period during which the transfer transistor TG-B is turned off) is continued for a light-emitted period of the emission light Li, the remaining period, that is, a light-unemitted period of the emission light Li, is a period during which the transfer transistor TG-B is turned on (i.e., a period during which the transfer transistor TG-A is turned off). That is, in one modulation period Pm during the light reception period Pr, an operation to allocate an electric charge of the photodiode PD to the floating diffusions FD-A and FD-B is repeated a predetermined number of times.

Then, after the light reception period Pr ends, the pixels Px″ of the pixel array section 111 are selected line-sequentially. The selection transistors SEL-A and SEL-B of selected pixels Px″ are turned on. Thereby, electric charges accumulated in the floating diffusions FD-A are output to the column processing section 115 via the vertical signal wires 122-A. In addition, electric charges accumulated in the floating diffusions FD-B are output to the column processing section 115 via the vertical signal wires 122-B.

With the operation above, one light receiving operation ends, and the next light receiving operation starting from the reset operation is executed.

Here, the reflection light Lr received by a pixel Px″ is delayed from the timing at which the light-emitting section 36 emitted the emission light Li according to the distance to the target object Ob. Since the allocation ratio of electric charges accumulated in the two floating diffusions FD-A and FD-B changes due to the delay according to the distance to the target object Ob, it is possible to determine the distance to the target object Ob from the allocation ratio of the electric charges accumulated in the two floating diffusions FD-A and FD-B.

The explanation is continued with reference to FIG. 39 again.

The image generating section 33 generates multiple types of images on the basis of a RAW image output from the iToF sensor 32, specifically an image representing the amount of an electric charge accumulated in each floating diffusion by the allocation operation mentioned before for each pixel position. Specifically, the image generating section 33 has a distance image generating section 33a, an IR image generating section 33b, and a reliability image generating section 33c.

The distance image generating section 33a generates a distance image which is an image representing a distance measured for each pixel position. Specifically, the distance image generating section 33a calculates the distance to an object from which the reflection light Lr is received for each pixel position on the RAW image output from the iToF sensor 32 by performing a predetermined computation by the iToF scheme based on the amount of an accumulated electric charge of each floating diffusion FD of the pixel position.

Note that a known approach can be used as an approach to calculating distance information by the iToF scheme on the basis of two types of sensing signal (the amount of an accumulated electric charge of each floating diffusion FD) for each pixel position, and an explanation thereof is omitted here.

The IR image generating section 33b calculates the reception-light amount of IR light on the basis of the amount of an accumulated electric charge of each floating diffusion FD for each pixel position on the RAW image output from the iToF sensor 32, and generates an IR image. Specifically, the IR image generating section 33b generates the IR image representing the reception-light amount of IR light for each pixel position by adding the amount of an accumulated electric charge of each floating diffusion FD of the pixel position.

The reliability image generating section 33c generates a reliability image by calculating a distance measurement reliability which is an index about the reliability of distance measurement on the basis of the amount of an accumulated electric charge of each floating diffusion FD for each pixel position on the RAW image output from the iToF sensor 32.

Here, the reliability of distance measurement is correlated with the light-reception intensity of the reflection light Lr. Because of this, the reliability image generating section 33c generates the reliability image which is an image representing the distance measurement reliability for each pixel position on the RAW image output from the iToF sensor 32 by performing a known computation for determining the light-reception intensity for the amount of an accumulated electric charge of each floating diffusion FD of the pixel position.

As depicted in the figure, the IR image generated by the IR image generating section 33b is output to the signal processing section 34 and the detecting section 38.

In addition, the reliability image generated by the reliability image generating section 33c is input by the control section 35.

The signal processing section 34 performs a digital gain adjustment process as signal processing on the IR image input from the IR image generating section 33b.

The detecting section 37 performs detection on the RAW image output from the iToF sensor 32, and outputs detected values to the control section 35.

In addition, the detecting section 38 performs detection on the IR image output by the IR image generating section 33b, and outputs detected values to the control section 35.

The control section 35 performs the light-emitting operation control of the light-emitting section 36 mentioned above, and light reception period adjustment (exposure adjustment) of the iToF sensor 32 based on the detected values of the RAW image obtained by the detecting section 37, and the reliability image. That is, the control section 35 performs adjustment of the light reception periods Pr mentioned before.

Specifically, on the basis of the detected values of the RAW image, the control section 35 performs the exposure adjustment of the iToF sensor 32 such that the amount of an accumulated electric charge of each floating diffusion FD does not get saturated. Note that, just for reminding, saturation sensing of each floating diffusion FD cannot be performed depending on the detected values of the IR image obtained by the detecting section 38 (since the IR image represents the sum of the accumulated electric charges of the floating diffusions FD). Because of this, the saturation prevention control uses the detected values of the RAW image.

In addition, the control section 35 performs the exposure adjustment of the iToF sensor 32 based on the distance measurement reliability while performing the saturation prevention control like the one described above. For example, the control section 35 performs the exposure adjustment of the iToF sensor 32 such that the distance measurement reliability becomes equal to or greater than a certain reliability.

Here, in a case where the exposure adjustment prioritizing distance measurement reliability (prioritizing distance measurement accuracy) is performed as described above, it is not guaranteed that the exposure adjustment becomes appropriate for the IR image. That is, it is not guaranteed that the brightness of the IR image becomes appropriate.

Because of this, the control section 35 controls signal processing parameters of the digital gain adjustment process at the signal processing section 34 on the basis of the detected values of the IR image obtained by the detecting section 38. Specifically, the control section 35 controls signal processing parameters of the digital gain adjustment process such that the brightness of the IR image becomes appropriate.

Thereby, it is possible to attempt to make the brightness of the IR image appropriate while making use of functions of the exposure adjustment of the iToF sensor 32 based on the distance measurement reliability. That is, it is possible to attempt to pursue both enhancement of the distance measurement accuracy and appropriate brightness of the IR image, and it is possible to attempt to obtain an appropriate image of each of multiple images generated on the basis of outputs of the iToF sensor 32.

Note that whereas it is assumed that the light reception period adjustment of the iToF sensor 32 is performed on the basis of the distance measurement reliability in the description above, as another example, there can also be configuration in which an application designates light reception periods of the iToF sensor 32.

Here, in a case where the brightness adjustment of the IR image like the one described above is performed, it should be attempted to prevent image quality deterioration of the IR image due to an excessive gain for the brightness adjustment.

Because of this, it is possible that the control section 35 performs control like the one below.

That is, the control section 35 performs gain limit control of the digital gain adjustment process of the IR image at the signal processing section 34, and performs the light reception period adjustment of the iToF sensor 32 on the basis of a result of comparison between a target gain of the digital gain adjustment process on the IR image determined on the basis of the detected values of the IR image and a gain limit value in the limit control described above. At this time, the gain limit value in the limit control described above is set such that image quality deterioration of the IR image can be kept equal to or lower than a predetermined degree of deterioration. In addition, the light reception period adjustment based on the result of comparison between the target gain and the limit value in the limit control described above is performed such that, for example, adjustment of the brightness equivalent to the difference gain between the target gain and the limit value is performed by light reception periods of the iToF sensor 32 in a case where the target gain exceeds the limit value.

Thereby, in a case where the target gain becomes excessive in the brightness adjustment by the gain adjustment of the IR image, adjustment is performed not only with the gain, but it is attempted to make the brightness of the IR image appropriate by giving an offset to the exposure adjustment of the iToF sensor 32.

Note that it is also possible that the signal processing device 31 is not provided with the detecting section 38 for performing detection on the IR image due to some circumstance.

In that case, detected values of the IR image may be estimated on the basis of detected values of the RAW image, that is, a detected value of the amount of an accumulated electric charge of each floating diffusion FD. Specifically, detected values of the IR image are estimated by adding together detected values of the amounts of accumulated electric charges of the floating diffusions FD for each pixel position.

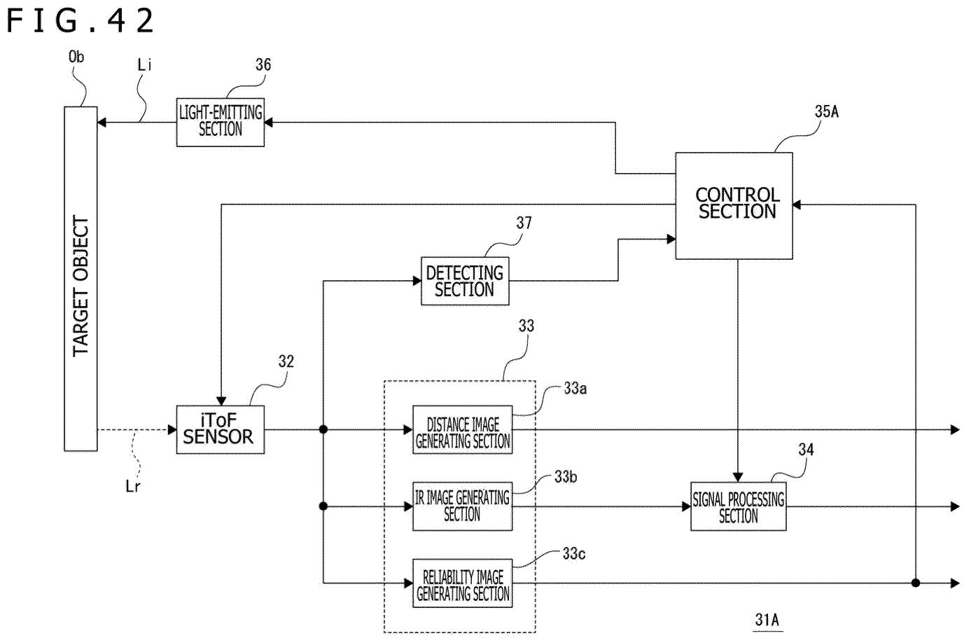

FIG. 42 is a block diagram for explaining a configuration example of a signal processing device 31A having such a function to estimate detected values of an IR image.

As compared with the signal processing device 31, the detecting section 38 is omitted from the signal processing device 31A, and the signal processing device 31A is provided with a control section 35A instead of the control section 35. The control section 35A is different from the control section 35 in that the control section 35A estimates detected values of an IR image used for the brightness adjustment of the IR image like the one mentioned above on the basis of detected values of a RAW image obtained by the detecting section 37.

Note that detected values of an IR image can also be estimated on the basis of distance measurement reliabilities represented by a reliability image. Alternatively, it is possible also that detected values of an IR image are estimated as the total amount of detection signals of a RAW image.

In addition, in the third embodiment also, detected values can also be inferred using an artificial intelligence model from detected values of other images.

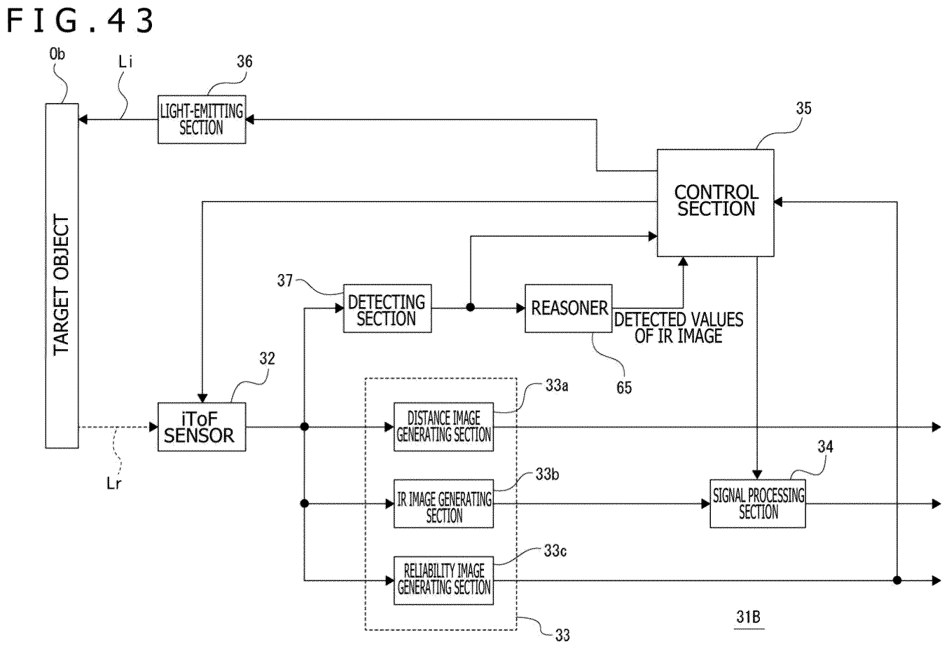

FIG. 43 is a block diagram for explaining a configuration example of a signal processing device 31B that infers detected values of an IR image from detected values of a RAW image.

A difference from the signal processing device 31 is that the detecting section 38 is omitted from the signal processing device 31B, and the signal processing device 31B additionally has a reasoner 65. The reasoner 65 infers detected values of an IR image by using an artificial intelligence model and receiving inputs of detected values of a RAW image obtained by the detecting section 37. The artificial intelligence model used at the reasoner 65 can be obtained by machine learning using detected values of RAW images obtained by the iToF sensor 32 as training input data, and using detected values of IR images as correct answer data.

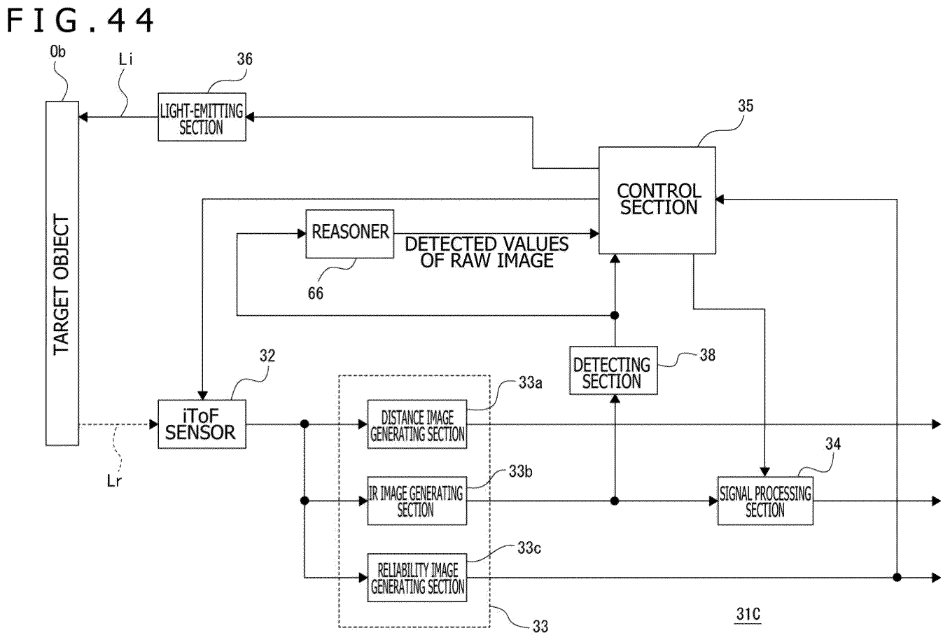

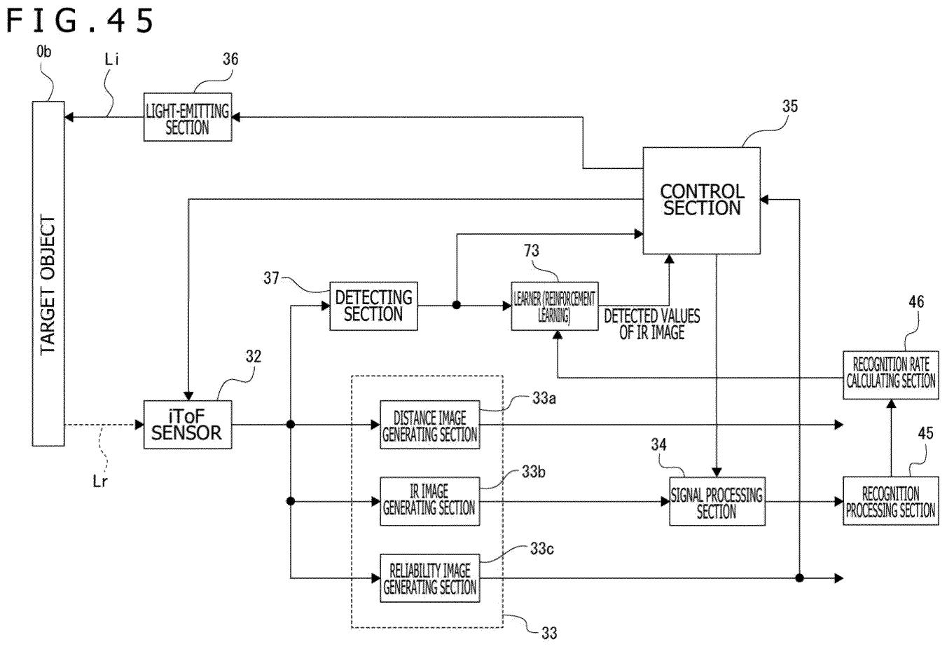

FIG. 44 is a block diagram for explaining a configuration example of a signal processing device 31C that infers detected values of a RAW image of the iToF sensor 32 from detected values of an IR image.

A difference from the signal processing device 31 is that the detecting section 37 is omitted from the signal processing device 31C, and the signal processing device 31C additionally has a reasoner 66. The reasoner 66 infers detected values of a RAW image obtained by the iToF sensor 32 by using an artificial intelligence model and receiving inputs of detected values of an IR image obtained by the detecting section 38. The artificial intelligence model used at the reasoner 66 can be obtained by machine learning using detected values of IR images as training input data, and using detected values of RAW images obtained by the iToF sensor 32 as correct answer data.

Here, in the third embodiment also, it is possible also that relearning of the artificial intelligence model of the reasoner is performed by a procedure similar to that in the case of the sixth example in the first embodiment. For example, the relearning is performed when a predetermined condition related to a length of elapsed time, the operation situation of AE, or the like is satisfied, and so on.

In addition, in a case where the relearning is performed, it is possible also to perform control to update the artificial intelligence model based on results of evaluation regarding inference results of the relearning model like the one explained in relation to the validating section F2 or the model update control section F3 mentioned before.

In addition, it is possible also that it is attempted to enhance the accuracy of an artificial intelligence model used for inference of detected values in an image recognition process performed using an IR image.

The image recognition process mentioned here means a process of recognizing a particular object such as recognition of a user face, for example.

FIG. 45 depicts a configuration example of a learning device used for learning by an artificial intelligence model as learning for such image recognition accuracy enhancement in a case where detected values of an IR image are inferred from a RAW image as in the signal processing device 31B in FIG. 43.

As depicted in the figure, the learning device in this case is provided with a recognition processing section 45 that performs an image recognition process on an IR image after gain adjustment by the signal processing section 34, a recognition rate calculating section 46 that calculates a rate of recognition (e.g., a correct answer rate) of objects by the image recognition process performed by the recognition processing section 45, and a learner 73 that performs machine learning as reinforcement learning. The learner 73 receives inputs of detected values of RAW images obtained by the detecting section 37 as input data for learning, and receives inputs of recognition rates calculated by the recognition rate calculating section 46 as reward (score) data. Since the learner 73 performs reinforcement learning using detected values of RAW images as input data, and recognition rates as reward data in this manner, it becomes possible to obtain an artificial intelligence model that can enhance the rate of image recognition based on IR images in a case where the artificial intelligence model is applied to the reasoner 65.

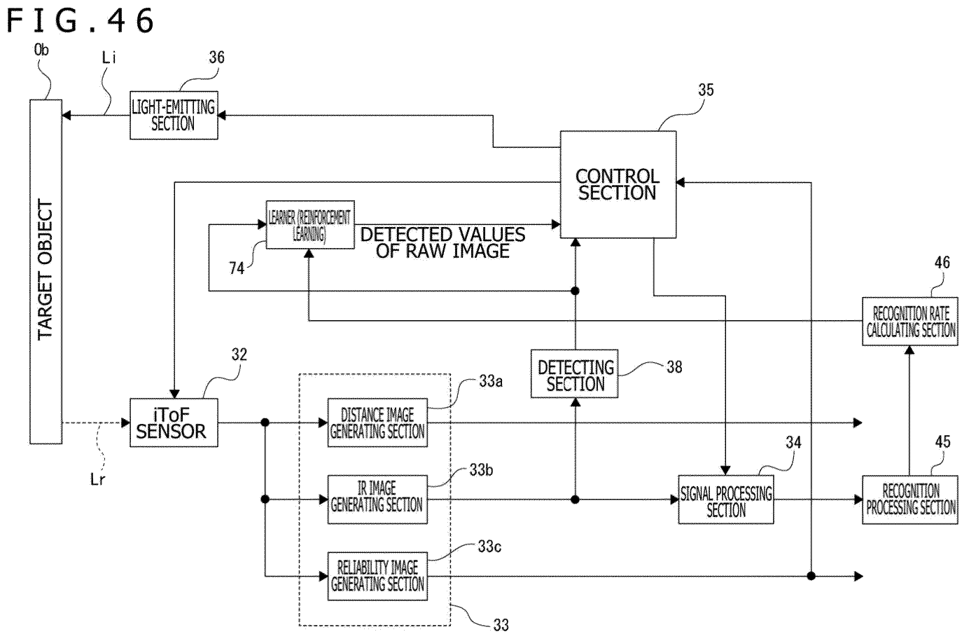

FIG. 46 depicts a configuration example of a learning device used for learning by an artificial intelligence model in a case where detected values of a RAW image are inferred from an IR image as in the signal processing device 31C in FIG. 44.

The learning device in this case is provided with a learner 74 instead of the learner 73. The learner 74 also is a learner supporting machine learning as reinforcement learning, similarly to the learner 73.

The learner 74 receives inputs of detected values of IR images obtained by the detecting section 38 as input data for learning, and receives inputs of recognition rates calculated by the recognition rate calculating section 46 as reward data. Since the learner 74 performs reinforcement learning using detected values of IR images as input data, and recognition rates as reward data in this manner, it becomes possible to obtain an artificial intelligence model that can enhance the rate of image recognition based on IR images in a case where the artificial intelligence model is applied to the reasoner 66.

### 4. Modification Example

Note that embodiments are not limited to the specific examples explained by the description above, and configuration as diverse modification examples can be adopted.

For example, whereas the polarization sensor 12, the spectral sensor 22, and the iToF sensor 32 are illustrated as examples of the light reception sensor 2 in the description above, the light reception sensor 2 is not limited to these sensors, and, for example, other sensors such as a thermal sensor for obtaining thermal images which are images representing temperature for each pixel position can also be used.

In addition, examples of signal processing by the signal processing sections are not limited to illustrated digital gain adjustment processes or matrix computation processes for band thinning processes, and, for example, other processes such as various types of images correction processing such as NR (noise reduction) processes can also be applied.

### 5. About Program

Here, the present technology can be implemented as a program invention for realizing processes performed by the control sections 15, 25, and 35, and the like explained thus far.

That is, a program according to an embodiment is a program that can be read by a computer device, the program causing the computer device to execute a process of controlling signal processing parameters of a signal processing section that performs signal processing on at least one image in multiple types of images generated on the basis of an output of a light reception sensor in which pixels having light receiving elements are arrayed two-dimensionally, the signal processing parameters being controlled such that the modes of the multiple types of images become appropriate.

Such a program can be stored in advance on the storage medium that can be read by the computer device, for example, a ROM, an HDD (Hard Disk Drive), an SSD (Solid State Drive), or the like. Alternatively, the program can be stored temporarily or permanently on a removable storage medium such as a semiconductor memory, a memory card, an optical disc, a magneto-optical disc, or a magnetic disc. In addition, such a removable storage medium can be provided as generally-called package software.

In addition, such a program can also be downloaded from a download site onto a predetermined information processing device such as a smartphone via a network such as a LAN or the Internet, other than being installed from a removable storage medium onto a personal computer or the like.

### 6. Summary of Embodiments

As explained in the description above, a signal processing device (11, 11A to 11I, 11C′, 11I′, 21, 21A to 21F, 31, 31A, 31B, 31C) as an embodiment includes a signal processing section (14, 14I, 14J, 24, 24A, 34) that performs signal processing on at least one image in multiple types of images generated on the basis of an output of a light reception sensor in which pixels having light receiving elements are arrayed two-dimensionally, and a control section (15, 15A, 15B, 15C, 15D, 15H, 15I, 15J, 25, 25A, 25C, 25F, 35, 35A) that controls signal processing parameters of the signal processing section such that the modes of the multiple types of images become appropriate.

Thereby, it is attempted to perform signal processing for making it possible to obtain images in appropriate modes in a case where multiple types of images are generated on the basis of an output of the light reception sensor. For example, it is attempted to perform signal processing for making the brightness or white balance of images appropriate or for performing appropriate image generation from multiple images, or the like.

Accordingly, it is possible to attempt to acquire appropriate images in a case where multiple types of images are generated on the basis of an output of the light reception sensor.

In addition, in the signal processing device as the embodiment, the signal processing section performs a digital gain adjustment process as the signal processing.

Thereby, it becomes possible to adjust the brightness of each image to appropriate brightness, coping with a case where differences in brightness are generated between the multiple types of images.

Accordingly, it is possible to attempt to acquire images with appropriate brightness in a case where multiple types of images are generated on the basis of an output of the light reception sensor.

Furthermore, in the signal processing device as the embodiment, the control section performs the process of controlling the signal processing parameters on the basis of detected values of a processing target image which is a target image of the signal processing by the signal processing section in the multiple types of images, and the signal processing device includes a reasoner (60, 63, 65) that infers, on the basis of a RAW image which is an output image of the light reception sensor, the detected values of the processing target image by using an artificial intelligence model generated by machine learning.

Thereby, it becomes unnecessary to provide a detecting section for performing detection on the processing target image in making it possible to appropriately perform the signal processing on the processing target image according to the detected values of the processing target image.

Accordingly, it is possible to attempt to reduce the number of parts of and the size of the signal processing device.

Still furthermore, the signal processing device as the embodiment includes a reasoner (61, 62, 64, 66) that infers, on the basis of at least any image in the multiple types of images, detected values of another type of image by using an artificial intelligence model generated by machine learning.

For example, it is possible that detected values of one image in the multiple types of images are inferred on the basis of other images in the multiple types of images, detected values of a RAW image are inferred on the basis of one image in the multiple types of images, and so on.

Thereby, it is possible to attempt to reduce the number of detecting sections, and it is possible to attempt to reduce the number of parts of and the size of the signal processing device.

In addition, in the signal processing device as the embodiment, the control section evaluates a result of inference performed by applying, to the reasoner, a relearning model which is the artificial intelligence model after relearning, and controls application of the artificial intelligence model to the reasoner on the basis of an evaluation result (see FIG. 21, etc.).

Thereby, it becomes possible to perform updating of the artificial intelligence model such that the artificial intelligence model produces favorable inference results in a real environment.

Furthermore, in the signal processing device as the embodiment, the light reception sensor is a polarization sensor.

By using the polarization sensor as the light reception sensor, it is possible to attempt to acquire appropriate polarization images such as by making the brightness of each image in the multiple types of polarization image such as a polarization component image, a reflection-removed image, or a reflection-enhanced image appropriate, depending on the signal processing devices.

Still furthermore, in the signal processing device as the embodiment, the signal processing section performs a digital gain adjustment process on at least one polarization image in multiple types of polarization image generated on the basis of an output of the polarization sensor.

Thereby, it becomes possible to perform signal processing on polarization images such that the brightness of each polarization image becomes appropriate in a case where the multiple types of polarization image such as a polarization component image, a reflection-removed image, or a reflection-enhanced image include at least one polarization image with brightness which is different from the brightness of other polarization images.

Accordingly, it is possible to attempt to acquire appropriate polarization images.

In addition, in the signal processing device as the embodiment, the polarization sensor is configured to be capable of receiving light with a color which differs depending on a polarization angle, as the polarization images, reflection-removed images of multiple colors and polarization component images of multiple colors are generated, the signal processing section is configured to be capable of executing a digital gain adjustment process for each color at least on the reflection-removed images, and the control section controls the digital gain adjustment process on the reflection-removed images by the signal processing section on the basis of detected values of each color of the polarization component images (see FIG. 25, etc.).

The reflection-removed images are images in which unnecessary reflection is reduced, and are images suited for identification of the color of a subject. In addition, the polarization component images are equivalent to images capturing specular reflection components generated from direct reflection of the colors of light sources, and allow identification of the light source colors on the basis of detected values of each color of the polarization component images. Because of this, by controlling the digital gain adjustment process (i.e., the white balance adjustment process) of each color of the reflection-removed images on the basis of detected values of each color of the polarization component images as described above, it becomes possible to obtain color information in which the light source colors are canceled, as color information represented by the reflection-removed images.

Accordingly, it is possible to appropriately identify the true color of the subject.

Furthermore, in the signal processing device as the embodiment, the control section controls the digital gain adjustment process on the reflection-removed images by the signal processing section on the basis of detected values of polarization component images in target subject areas which are partial areas in the polarization component images.

In a case where the color of a target subject in an image frame is to be identified, the MIX ratio of the light source colors of multiple light sources differs, that is, the light source colors differ, by position in the image frame in an environment with a MIX light source in which light from the multiple light sources is emitted to a subject. In view of this, as described above, the digital gain adjustment of each color of the reflection-removed images is performed on the basis of the detected values of the polarization component images in the target subject areas. That is, in the identification of the color of the target subject, the light source colors in the target subject areas are canceled.

Accordingly, it is possible to appropriately identify the true color of the target subject.

Still furthermore, in the signal processing device as the embodiment, the light reception sensor is a spectral sensor.

By using the spectral sensor as the light reception sensor, it is possible to attempt to acquire appropriate images such as by making the brightness of each image in the multiple narrow-band images appropriate, performing a particular type of image generation based on a request as an image generation process based on the multiple narrow-band images, and so on, depending on the signal processing devices.

In addition, in the signal processing device as the embodiment, the signal processing section performs a digital gain adjustment process on at least one image in multiple types of images generated on the basis of an output of the spectral sensor.

Thereby, it becomes possible to perform signal processing such that the brightness of each image becomes appropriate in a case where the multiple types of images generated on the basis of the output of the spectral sensor include at least one image with brightness which is different from the brightness of other images.

Accordingly, it is possible to attempt to acquire appropriate images as images based on the output of the spectral sensor.

Furthermore, in the signal processing device as the embodiment, the signal processing section performs a band thinning matrix computation process on multiple narrow-band images generated on the basis of an output of the spectral sensor.

Thereby, it becomes possible to obtain a desired image group in which a certain number of bands are thinned out from the multiple narrow-band images generated on the basis of the output of the spectral sensor. For example, it becomes possible to obtain a group of narrow-band images with a smaller number of bands, obtain an RGB image, and so on, from the multiple narrow-band images.

Accordingly, for example, it is possible to attempt to acquire appropriate images according to a request from an application or the like as images based on the output of the spectral sensor.

Still furthermore, in the signal processing device as the embodiment, the band thinning matrix computation process includes a process of generating a group of narrow-band images which are fewer than the number of the multiple narrow-band images, and a process of generating an RGB image, the signal processing section is configured to be capable of executing a digital gain adjustment process on the group of narrow-band images and a digital gain adjustment process on the RGB image, and the control section controls signal processing parameters of the digital gain adjustment process on the group of narrow-band images at the signal processing section on the basis of detected values of the group of narrow-band images, and controls signal processing parameters of the digital gain adjustment process on the RGB image at the signal processing section on the basis of detected values of the RGB image.

Thereby, it becomes possible to appropriately adjust the brightness of each image on the basis of detected values of the image, coping with a case where the brightness characteristics of the group of narrow-band images and the RGB image generated by the band thinning matrix computation process from the multiple narrow-band images are different from each other.

Accordingly, it is possible to attempt to acquire images with appropriate brightness as the group of narrow-band images and the RGB image generated by the band thinning matrix computation process.

In addition, in the signal processing device as the embodiment, the signal processing section is configured to be capable of executing a digital gain adjustment process on each of multiple narrow-band images generated on the basis of an output of the spectral sensor, and the control section controls the signal processing parameters of the digital gain adjustment process at the signal processing section on the basis of information regarding a light source color identified on the basis of detected values of each of the multiple narrow-band images.

Thereby, it becomes possible to perform the digital gain adjustment to cancel the light source color on the multiple narrow-band images generated on the basis of the output of the spectral sensor.

Accordingly, it is possible to attempt to acquire appropriate images, coping with a case where spectral characteristics information in which the light source color is canceled is requested as spectral characteristics information of a subject.

Furthermore, in the signal processing device as the embodiment, the light reception sensor is an iToF sensor.

By using the iToF sensor as the light reception sensor, it is possible to attempt to acquire appropriate images such as by making the brightness of an IR image generated on the basis of the output of the iToF sensor appropriate, depending on the signal processing devices.

Still furthermore, in the signal processing device as the embodiment, a distance image and an IR image are generated on the basis of an output of the iToF sensor, and as the signal processing, the signal processing section performs a digital gain adjustment process on the IR image.

Thereby, it becomes possible to perform signal processing such that the brightness of the IR image becomes appropriate.

Accordingly, it is possible to attempt to obtain an IR image with appropriate brightness in a case where multiple types of images including an IR image are generated on the basis of an output of the iToF sensor.

In addition, in the signal processing device as the embodiment, the control section performs light reception period adjustment of the iToF sensor on the basis of reliability information regarding a measured distance calculated on the basis of an output of the iToF sensor, and controls the signal processing parameters of the digital gain adjustment process at the signal processing section on the basis of detected values of the IR image.

In a case where the light reception period adjustment (exposure adjustment) of the iToF sensor prioritizing distance measurement is performed, it does not necessarily become exposure adjustment appropriate for the IR image. In view of this, the digital gain adjustment of the IR image is performed on the basis of the detected values of the IR image as described above.

Thereby, even in a case where exposure adjustment of the iToF sensor prioritizing distance measurement is performed, it is possible to attempt to obtain an IR image with appropriate brightness.

Furthermore, in the signal processing device as the embodiment, the control section performs gain limit control of the digital gain adjustment process of the IR image at the signal processing section, and performs the light reception period adjustment of the iToF sensor on the basis of a result of comparison between a target gain of the digital gain adjustment process on the IR image determined on the basis of the detected values of the IR image, and a gain limit value in the limit control.

With the gain limit control like the one described above, it is attempted to prevent undesirable significant deterioration of the image quality of the IR image due to excessive digital gain adjustment. Then, by performing the light reception period adjustment based on the result of the comparison between the target gain and the gain limit value like the one described above, it becomes possible to perform, by the light reception period adjustment of the iToF sensor, brightness adjustment by an amount corresponding to restriction by the limit control, and it becomes possible to attempt to make the brightness of the IR image appropriate brightness.

Accordingly, it is possible to attempt to pursue both reduction of image quality deterioration of the IR image and appropriate brightness of the IR image.

A signal processing method as an embodiment is a signal processing method executed by a signal processing device, the signal processing method including controlling signal processing parameters of a signal processing section that performs signal processing on at least one image in multiple types of images generated on the basis of an output of a light reception sensor in which pixels having light receiving elements are arrayed two-dimensionally, the signal processing parameters being controlled such that the modes of the multiple types of images become appropriate.

With such a signal processing method also, effects and advantages similar to those of the signal processing device as the embodiment described above can be achieved.

Note that advantages described in the present specification are merely illustrated as examples, and are not the sole examples, and there may be other advantages.

### 7. Present Technology

Note that the present technology can also adopt configuration like the ones below.

(1)

A signal processing device including:
a signal processing section that performs signal processing on at least one image in multiple types of images generated on the basis of an output of a light reception sensor in which pixels having light receiving elements are arrayed two-dimensionally; and
a control section that controls a signal processing parameter in the signal processing section such that modes of the multiple types of images become appropriate.
   (2)

The signal processing device according to (1) above, in which the signal processing section performs a digital gain adjustment process as the signal processing.

(3)

The signal processing device according to (1) or (2) above, in which
the control section performs a process of controlling the signal processing parameter on the basis of a detected value of a processing target image that is a target image of the signal processing by the signal processing section in the multiple types of images, and
the signal processing device includes a reasoner that infers, on the basis of a RAW image which is an output image of the light reception sensor, the detected value of the processing target image by using an artificial intelligence model generated by machine learning.
   (4)

The signal processing device according to any one of (1) to (3) above, including:
a reasoner that infers, on the basis of at least any image in the multiple types of images, a detected value of another type of image by using an artificial intelligence model generated by machine learning.
   (5)

The signal processing device according to (3) or (4) above, in which the control section evaluates a result of inference performed by applying, to the reasoner, a relearning model that is the artificial intelligence model after relearning, and controls application of the artificial intelligence model to the reasoner on the basis of an evaluation result.

(6)

The signal processing device according to any one of (1) to (5) above, in which the light reception sensor is a polarization sensor.

(7)

The signal processing device according to (6) above, in which the signal processing section performs a digital gain adjustment process on at least one polarization image in multiple types of polarization image generated on the basis of an output of the polarization sensor.

(8)

The signal processing device according to (7) above, in which
the polarization sensor is configured to be capable of receiving light with a color which differs depending on a polarization angle,
as the polarization images, reflection-removed images of multiple colors and polarization component images of multiple colors are generated,
the signal processing section is configured to be capable of executing a digital gain adjustment process for each color at least on the reflection-removed images, and
the control section controls the digital gain adjustment process on the reflection-removed images by the signal processing section on the basis of a detected value of each color of the polarization component images.
   (9)

The signal processing device according to (8) above, in which the control section controls the digital gain adjustment process on the reflection-removed images by the signal processing section on the basis of detected values of polarization component images in target subject areas that are partial areas in the polarization component images.

(10)

The signal processing device according to any one of (1) to (5) above, in which the light reception sensor is a spectral sensor.

(11)

The signal processing device according to (10) above, in which the signal processing section performs a digital gain adjustment process on at least one image in multiple types of images generated on the basis of an output of the spectral sensor.

(12)

The signal processing device according to (10) or (11) above, in which the signal processing section performs a band thinning matrix computation process on multiple narrow-band images generated on the basis of an output of the spectral sensor.

(13)

The signal processing device according to (12) above, in which
the band thinning matrix computation process includes a process of generating a group of narrow-band images that are fewer than the number of the multiple narrow-band images, and a process of generating an RGB image,
the signal processing section is configured to be capable of executing a digital gain adjustment process on the group of narrow-band images and a digital gain adjustment process on the RGB image, and
the control section controls a signal processing parameter of the digital gain adjustment process on the group of narrow-band images at the signal processing section on the basis of a detected value of the group of narrow-band images, and controls a signal processing parameter of the digital gain adjustment process on the RGB image at the signal processing section on the basis of a detected value of the RGB image.
   (14)

The signal processing device according to any one of (11) to (13) above, in which
the signal processing section is configured to be capable of executing a digital gain adjustment process on each of multiple narrow-band images generated on the basis of an output of the spectral sensor, and
the control section controls the signal processing parameter of the digital gain adjustment process at the signal processing section on the basis of information regarding a light source color identified on the basis of a detected value of each of the multiple narrow-band images.
   (15)

The signal processing device according to any one of (1) to (5) above, in which the light reception sensor is an iToF sensor.

(16)

The signal processing device according to (15) above, in which
a distance image and an IR image are generated on the basis of an output of the iToF sensor, and,
as the signal processing, the signal processing section performs a digital gain adjustment process on the IR image.
   (17)

The signal processing device according to (16) above, in which the control section performs light reception period adjustment of the iToF sensor on the basis of reliability information regarding a measured distance calculated on the basis of an output of the iToF sensor, and controls the signal processing parameter of the digital gain adjustment process at the signal processing section on the basis of a detected value of the IR image.

(18)

The signal processing device according to (17) above, in which the control section performs gain limit control of the digital gain adjustment process of the IR image at the signal processing section, and performs the light reception period adjustment of the iToF sensor on the basis of a result of comparison between a target gain of the digital gain adjustment process on the IR image determined on the basis of the detected value of the IR image, and a gain limit value in the limit control.

(19)

A signal processing method executed by a signal processing device, the signal processing method including:
controlling a signal processing parameter of a signal processing section that performs signal processing on at least one image in multiple types of images generated on the basis of an output of a light reception sensor in which pixels having light receiving elements are arrayed two-dimensionally, the signal processing parameter being controlled such that modes of the multiple types of images become appropriate.
   (20)

A program that is possible to be read by a computer device, the program causing the computer device to execute:
a process of controlling a signal processing parameter of a signal processing section that performs signal processing on at least one image in multiple types of images generated on the basis of an output of a light reception sensor in which pixels having light receiving elements are arrayed two-dimensionally, the signal processing parameter being controlled such that modes of the multiple types of images become appropriate.

### REFERENCE SIGNS LIST

1, 11, 11A to 11I, 11C′, 11I′, 21, 21A to 21F, 31, 31A,
31B, 31C: Signal processing device
2: Light reception sensor
3: Image generating section
4, 14, 14I, 14J, 24, 24A, 34: Signal processing section
5, 15, 15A, 15B, 15C, 15D, 15H, 15I, 15J, 25, 25A, 25C, 25F, 35, 35A: Control section
12: Polarization sensor
13: Polarization image generating section
13a: Image organizing section
13b: Demosaicing section
13c: Polarization state estimating section
13d: Polarization image generation processing section
Ap: Application
Px, Px′, Px″: Pixel
PP: Polarization pixel unit
PC: Color polarization pixel unit
16, 17: Detecting section
18: RGB detecting section
60, 61, 62, 63, 64, 65, 66: Reasoner
70, 71, 72, 73: Learner
80, 80J, 81: Object sensing section
200: Relearning device
F1: Relearning start control section
F2: Validating section
F3: Model update control section
At, At1, At2: Target subject area
22: Spectral sensor
23: Spectral image generating section
23a: Demosaicing section
23b: Narrow-band image generating section
26, 29-1, 29-2, 40: Detecting section
27: Memory
28: Evaluation value calculating section
Pu: Spectral pixel unit
Ic: Light source color information
32: iToF sensor
33: Image generating section
33a: Distance image generating section
33b: IR image generating section
33c: Reliability image generating section
36: Light-emitting section
37, 38: Detecting section
Ob: Target object
Li: Emission light
Lr: Reflection light
45: Recognition processing section
46: Recognition rate calculating section
111: Pixel array section
PD: Photodiode
FD, FD-A, FD-B: Floating diffusion

The invention claimed is:

1. A signal processing device comprising:
a signal processing section that performs signal processing on at least one image in multiple types of images generated on a basis of an output of a light reception sensor in which pixels having light receiving elements are arrayed two-dimensionally; and
a control section that controls a signal processing parameter in the signal processing section such that modes of the multiple types of images become appropriate.

2. The signal processing device according to claim 1, wherein the signal processing section performs a digital gain adjustment process as the signal processing.

3. The signal processing device according to claim 1, wherein
the control section performs a process of controlling the signal processing parameter on a basis of a detected value of a processing target image that is a target image of the signal processing by the signal processing section in the multiple types of images, and
the signal processing device includes a reasoner that infers, on a basis of a RAW image which is an output image of the light reception sensor, the detected value of the processing target image by using an artificial intelligence model generated by machine learning.

4. The signal processing device according to claim 1, comprising:
a reasoner that infers, on a basis of at least any image in the multiple types of images, a detected value of another type of image by using an artificial intelligence model generated by machine learning.

5. The signal processing device according to claim 3, wherein the control section evaluates a result of inference performed by applying, to the reasoner, a relearning model that is the artificial intelligence model after relearning, and controls application of the artificial intelligence model to the reasoner on a basis of an evaluation result.

6. The signal processing device according to claim 1, wherein the light reception sensor is a polarization sensor.

7. The signal processing device according to claim 6, wherein the signal processing section performs a digital gain adjustment process on at least one polarization image in multiple types of polarization image generated on a basis of an output of the polarization sensor.

8. The signal processing device according to claim 7, wherein
the polarization sensor is configured to be capable of receiving light with a color which differs depending on a polarization angle,
as the polarization images, reflection-removed images of multiple colors and polarization component images of multiple colors are generated,
the signal processing section is configured to be capable of executing a digital gain adjustment process for each color at least on the reflection-removed images, and
the control section controls the digital gain adjustment process on the reflection-removed images by the signal processing section on a basis of a detected value of each color of the polarization component images.

9. The signal processing device according to claim 8, wherein the control section controls the digital gain adjustment process on the reflection-removed images by the signal processing section on a basis of detected values of polarization component images in target subject areas that are partial areas in the polarization component images.

10. The signal processing device according to claim 1, wherein the light reception sensor is a spectral sensor.

11. The signal processing device according to claim 10, wherein the signal processing section performs a digital gain adjustment process on at least one image in multiple types of images generated on a basis of an output of the spectral sensor.

12. The signal processing device according to claim 10, wherein the signal processing section performs a band thinning matrix computation process on multiple narrow-band images generated on a basis of an output of the spectral sensor.

13. The signal processing device according to claim 12, wherein
the band thinning matrix computation process includes a process of generating a group of narrow-band images that are fewer than the number of the multiple narrow-band images, and a process of generating an RGB image,
the signal processing section is configured to be capable of executing a digital gain adjustment process on the group of narrow-band images and a digital gain adjustment process on the RGB image, and
the control section controls a signal processing parameter of the digital gain adjustment process on the group of narrow-band images at the signal processing section on a basis of a detected value of the group of narrow-band images, and controls a signal processing parameter of the digital gain adjustment process on the RGB image at the signal processing section on a basis of a detected value of the RGB image.

14. The signal processing device according to claim 11, wherein
the signal processing section is configured to be capable of executing a digital gain adjustment process on each of multiple narrow-band images generated on a basis of an output of the spectral sensor, and
the control section controls the signal processing parameter of the digital gain adjustment process at the signal processing section on a basis of information regarding a light source color identified on a basis of a detected value of each of the multiple narrow-band images.

15. The signal processing device according to claim 1, wherein the light reception sensor is an iToF sensor.

16. The signal processing device according to claim 15, wherein
a distance image and an IR image are generated on a basis of an output of the iToF sensor, and,
as the signal processing, the signal processing section performs a digital gain adjustment process on the IR image.

17. The signal processing device according to claim 16, wherein the control section performs light reception period adjustment of the iToF sensor on a basis of reliability information regarding a measured distance calculated on a basis of an output of the iToF sensor, and controls the signal processing parameter of the digital gain adjustment process at the signal processing section on a basis of a detected value of the IR image.

18. The signal processing device according to claim 17, wherein the control section performs gain limit control of the digital gain adjustment process of the IR image at the signal processing section, and performs the light reception period adjustment of the iToF sensor on a basis of a result of comparison between a target gain of the digital gain adjustment process on the IR image determined on a basis of the detected value of the IR image, and a gain limit value in the limit control.

19. A signal processing method executed by a signal processing device, the signal processing method comprising:
controlling a signal processing parameter of a signal processing section that performs signal processing on at least one image in multiple types of images generated on a basis of an output of a light reception sensor in which pixels having light receiving elements are arrayed two-dimensionally, the signal processing parameter being controlled such that modes of the multiple types of images become appropriate.

20. A program that is possible to be read by a computer device, the program causing the computer device to execute:
a process of controlling a signal processing parameter of a signal processing section that performs signal processing on at least one image in multiple types of images generated on a basis of an output of a light reception sensor in which pixels having light receiving elements are arrayed two-dimensionally, the signal processing parameter being controlled such that modes of the multiple types of images become appropriate.
